(19) United States
(12) Patent Application Publication
(10) Pub. No.: US 2026/0067413 A1
(43) Pub. Date: Mar. 5, 2026

(54) INFORMATION PROCESSING APPARATUS, IMAGE FORMING SYSTEM, AND CREATION METHOD OF COLOR CONVERSION TABLE

(71) Applicant: CANON KABUSHIKI KAISHA, Tokyo (JP)

(72) Inventor: IKUMI YAMADA, Kanagawa (JP)

(21) Appl. No.: 19/291,374

(22) Filed: Aug. 5, 2025

(30) Foreign Application Priority Data
Aug. 27, 2024 (JP) 2024-145866

(51) Int. Cl. H04N 1/60; G06T 7/30; G06T 7/90; H04N 1/00

(52) U.S. Cl. CPC H04N 1/6052; G06T 7/30; G06T 7/90; G06T 2207/10008; G06T 2207/10024; G06T 2207/30176; H04N 1/00413

(57) ABSTRACT

An information processing apparatus that performs color matching based on document data and scan data is provided. The information processing apparatus receives an input of document data and an input of scan data, aligns the document data and the scan data, and creates a color conversion table for color matching for at least one color space of an object included in the document data based on the document data and the scan data that have been aligned.

### BACKGROUND

### Field of the Technology

The present disclosure relates to color matching of document data including objects of a plurality of color spaces, for example, and particularly relates to an information processing apparatus, an image forming system, and a creation method of a color conversion table.

### Description of the Related Art

In order to reproduce the same color as a color sample printed in the past, there is a method of realizing color matching by adjusting the color quality of an image forming apparatus or changing the color of document data itself. There is a method of creating a color conversion table defining a print target value regarding what color should be output with respect to a signal value of document data, and creating a color profile based on the color conversion table to realize color matching. In order to acquire the print target value, scan data (hereinafter, referred to as color sample scan data) in which a color sample is scanned is acquired using a colorimetric apparatus or a scanner that performs colorimetry or scanning of the color sample. The print target value can be acquired by performing color conversion from a signal value of the color sample scan data to an apparatus-independent signal value using a scanner profile in which the characteristics of the scanner are defined. A user can reproduce the same color as the color sample by printing document data using a color profile (hereinafter, referred to as a color matching color profile) for realizing color matching.

Data formats of document data include the portable document format (PDF). The PDF standards are defined by the International Organization for Standardization ISO, and one of them is PDF/X-4. In submission of document data in commercial printing, submission in PDF/X-4 is the mainstream. One of the features of PDF/X-4 is that objects having signal values of a plurality of color spaces different from each other, such as cyan (C) magenta (M) yellow (Y) black (K) and red (R) green (G) blue (B), can be mixed. For example, Japanese Patent Laid-Open No. 2021-57736 describes an example of a method of reproducing, with the same color as a color sample, document data including objects having signal values of the plurality of color spaces different from each other, that is, a plurality of objects in which colors are expressed by color systems different from each other. In Japanese Patent Laid-Open No. 2021-57736, first, it is determined whether document data includes a first area in which a first color conversion parameter is set and a second area in which a second color conversion parameter is set. Next, by performing color conversion setting at the time of printing the document data based on the determination result, it is possible to reproduce the same color as the color sample to print the document data including the objects having signal values of the plurality of color spaces.

However, in a known method of creating a color conversion table for reproducing the same color as the color sample to perform print, it is not determined whether document data has objects having signal values of the plurality of color spaces. Therefore, it is not possible to know where in the document data and the color sample scan data an object of what color space exists. As a result, the signal value of the document data and the print target value cannot be associated with each other for each color space, and therefore a color conversion table for each color space cannot be created.

In Japanese Patent Laid-Open No. 2021-57736, although color conversion setting when document data is printed is performed, it is not possible to create a color conversion table for each color space by associating a color sample with an image area of respective document data.

### SUMMARY

Therefore, a method of creating a color conversion table for reproducing the same color as the color sample with high accuracy for each color space when document data includes objects having signal values of a plurality of color spaces is provided.

According to one aspect of the present disclosure, an information processing apparatus that performs color matching based on document data and scan data, the information processing apparatus comprising: at least one memory storing instructions; and at least one processor that is in communication with the at least one memory and that, when executing the instructions, cooperates with the at least one memory to execute processing, the processing including receiving an input of document data and an input of scan data, aligning the document data and the scan data, and creating a color conversion table for color matching for at least one color space of an object included in the document data based on the document data and the scan data that have been aligned is provided.

According to the above configuration, even in document data having objects of signal values of a plurality of color spaces, a color conversion table for reproducing the same color as the color sample to print the document data can be created with high accuracy for each color space.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram illustrating a configuration of a client computer and an image forming apparatus.

FIG. 2 is a block diagram of a hardware configuration of the client computer and the image forming apparatus.

FIG. 3 is a block diagram of a software configuration of the client computer and the image forming apparatus.

FIGS. 4A to 4E are views illustrating document data and color sample scan data.

FIGS. 5A and 5B are views illustrating object information and a visible area.

FIGS. 6A and 6B are views illustrating object separation image data.

FIGS. 7A to 7F are views illustrating an extracted signal value table and a color conversion table.

FIG. 8A is a flowchart for creating a color conversion table for each color space.

FIG. 8B is a flowchart for creating a color conversion table for each color space.

FIGS. 9A to 9F are UI diagrams for creating a color conversion table for each color space.

FIGS. 10A and 10B are flowcharts for extracting a signal value for each color space.

FIGS. 11A to 11E are views illustrating document data and color sample scan data different from those in FIGS. 4A to 4E.

FIGS. 12A to 12E are views illustrating object information, an extracted signal value table, and a color conversion table.

FIGS. 13A to 13C are flowcharts for selecting a color space to create a color conversion table.

FIGS. 14A to 14C are UI diagrams for selecting a color space to create a color conversion table.

FIG. 15 is a flowchart for extracting a signal value for each selected color space.

FIGS. 16A and 16B are views illustrating an extracted signal value table for each selected color space.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### ● System Configuration

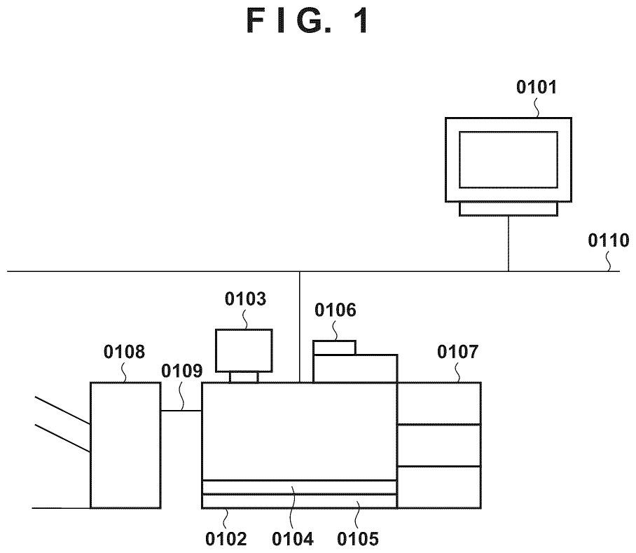

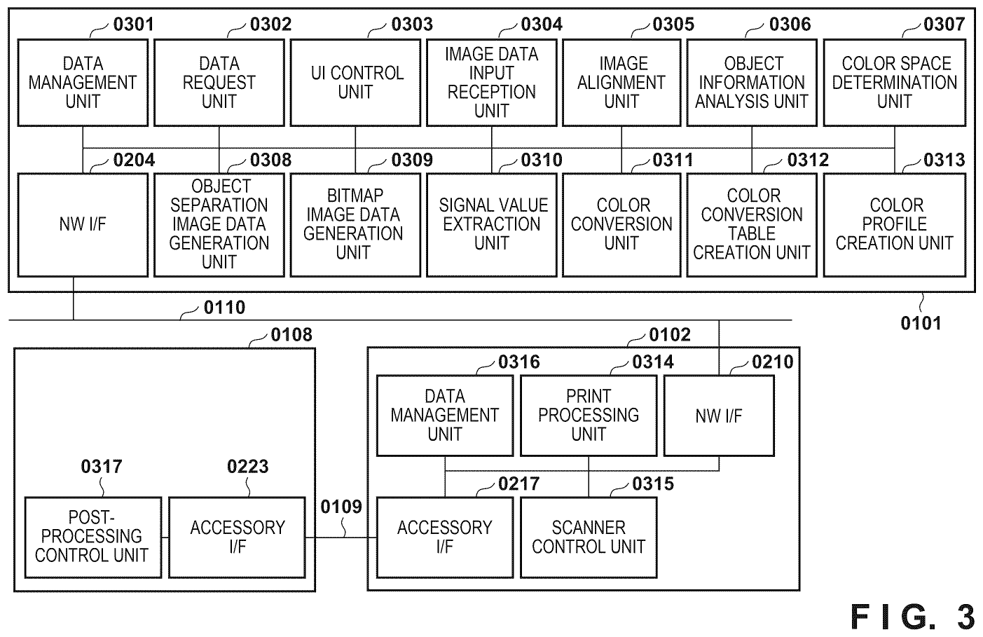

FIG. 1 is a schematic diagram illustrating an image forming system including a client computer and an image forming apparatus according to the present embodiment. A client computer 0101, which is an information processing apparatus, is connected to an image forming apparatus 0102 on an identical network via a network 0110. The client computer 0101 determines whether document data includes objects having signal values of a plurality of color spaces to create a color conversion table for each color space based on the document data and color sample scan data. That is, the color conversion table is created for each of at least one color space in which the signal value of the object included in the document data is specified. When creating the color conversion table for each color space, the client computer 0101 makes a request for data from the image forming apparatus 0102. Specifically, the client computer 0101 makes an acquisition request for color profile information from the image forming apparatus 0102 via the network 0110 based on the information having been set. This is executed by a control unit described later with reference to FIG. 3.

The image forming apparatus 0102 includes a user interface (UI) panel 0103, a paper feed deck 0104, a paper feed deck 0105, and a scanner (or image scanner) 0106. Furthermore, an option 0107 including three paper feed stages is connected. The image forming apparatus 0102 is, for example, an electrophotographic image forming apparatus. The UI panel 0103 is a user interface including, for example, a capacitive touch panel. The scanner 0106 includes a document plate on which a printed matter is placed, and can scan the printed matter placed thereon using a sensor and manage it as data.

The image forming apparatus 0102 further includes a paper discharging apparatus 0108. The paper discharging apparatus 0108 is connected to the image forming apparatus 0102 via a cable 0109. Furthermore, the paper discharging apparatus 0108 includes several paper discharging trays, and can load a product printed by the image forming apparatus 0102.

A print job is generated by the client computer 0101 and transmitted to the image forming apparatus 0102 via the network 0110, and the image forming apparatus 0102 performs processing of printing on a sheet. Not only one but a plurality of the image forming apparatuses 0102 may exist on the network 0110.

Note that the connection form between the client computer 0101 and the image forming apparatus 0102 illustrated in the present embodiment is an example, and it goes without saying that there are various connection forms other than that illustrated in the present embodiment.

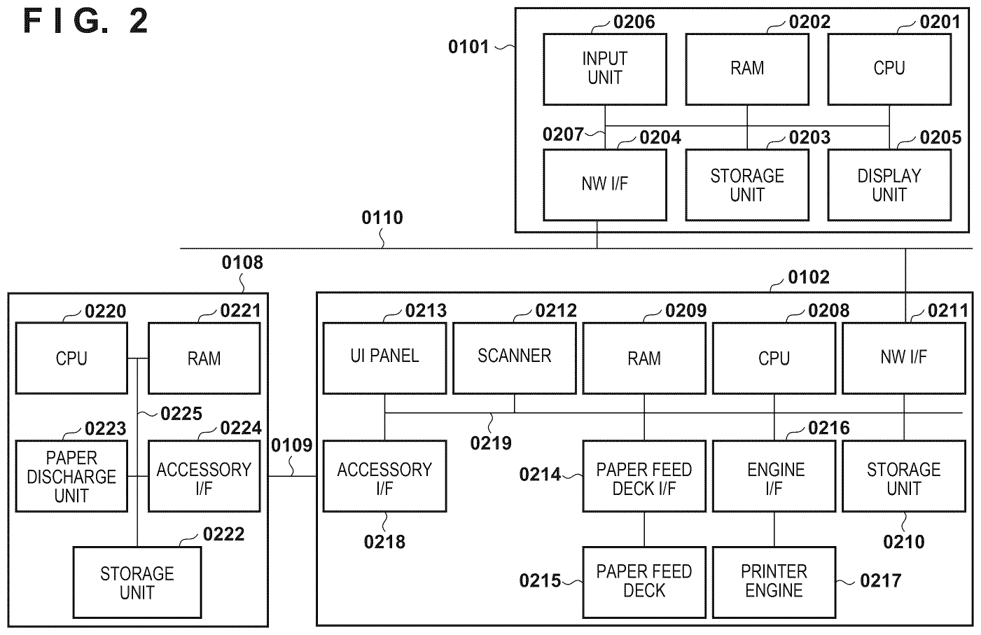

FIG. 2 is a block diagram illustrating a control configuration of the client computer 0101 and the image forming apparatus 0102 of the present embodiment.

### ● Client Computer

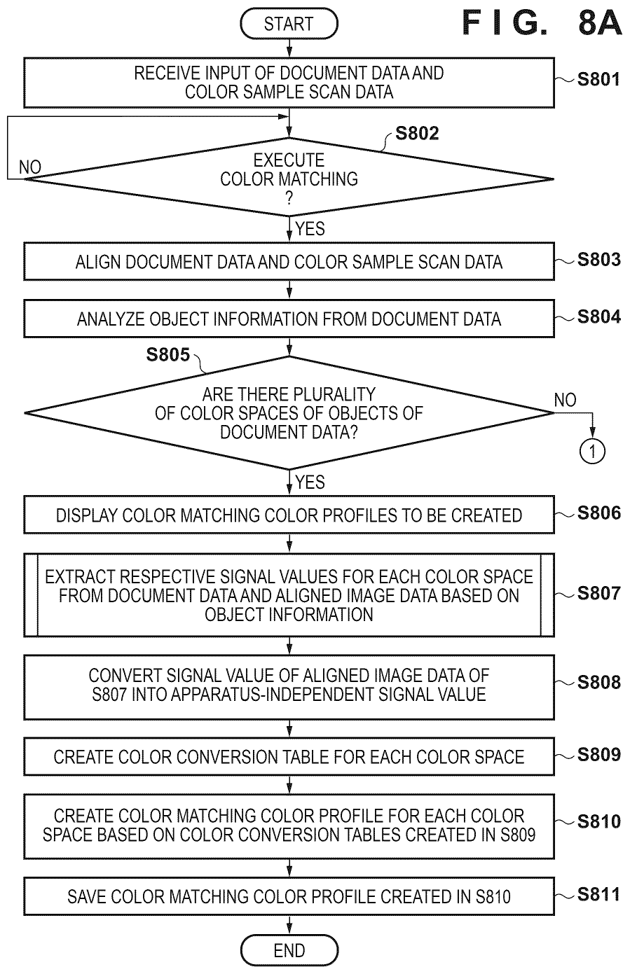

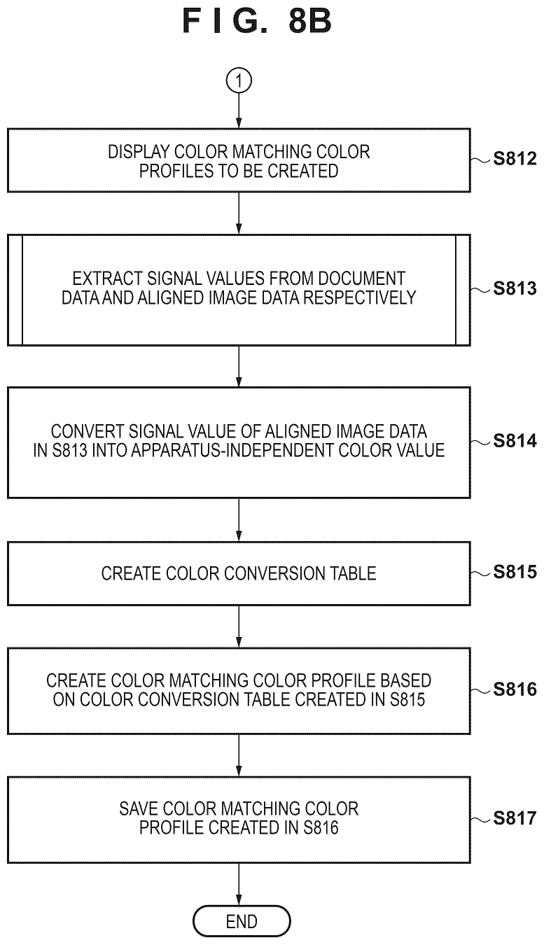

A central processing unit (CPU) 0201 manages control and computation in each unit of the client computer 0101 via a system bus 0207. The CPU 0201 manages execution of a program to be stored in the storage unit 0203 and loaded into a random access memory (RAM) 0202. The program to be stored in the storage unit 0203 includes a program for realizing each functional block illustrated in FIG. 3 and realizing the procedure of the flowchart shown in FIGS. 8A, 8B, 10A, 10B, 13A, 13B, 13C, 15, and the like. The program includes a command, and the CPU 0201 realizes a programmed function by executing the command included in the program. The RAM 0202 is a type of general volatile storage apparatus directly accessible from the CPU 0201, and is used as a work area or another temporary data storage area of the CPU 0201.

The storage unit 0203 also functions as a temporary storage area and a work memory during operation of the client computer.

A network interface (hereinafter, referred to as an NW I/F) 0204 is connected to an NW I/F 0211 of the image forming apparatus 0102 on the network via the network 0110, and manages communication between the client computer 0101 and the image forming apparatus 0102.

A display unit 0205 is a hardware component and is a user interface for visually showing information in the client computer 0101. The display unit 0205 is, for example, a monitor display.

An input unit 0206 is a hardware component and is a user interface for performing input to the client computer 0101. For example, the input unit 0206 is a keyboard, a pointing device, or the like. Depending on the form of the input unit 0206, there is a touch panel or the like integrated with the display unit 0205.

### ● Image Forming Apparatus

A CPU 0208 manages control and computation in each unit of the image forming apparatus 0102 via a system bus 0219. The CPU 0208 manages execution of a program to be stored in a storage unit 0210 and loaded into a RAM 0209.

The RAM 0209 is a type of general volatile storage apparatus directly accessible from the CPU 0208, and is used as a work area or another temporary data storage area of the CPU 0208. The storage unit 0210 also functions as a temporary storage area and a work memory during operation of the image forming apparatus.

The NW I/F 0211 is connected to the NW I/F 0204 of the client computer 0101 via the network 0110, and manages communication between the client computer 0101 and the image forming apparatus 0102.

A scanner 0212 is a hardware configuration corresponding to the scanner 0106, and can scan a surface of a printed matter or the like using a sensor and handle an image formed thereon as scan data (image data). The scanners 0212 include those including a mechanism that automatically conveys a printed matter to a document plate to execute scanning, which is called an automatic document feeder (ADF), and those including only a document plate for reading a printed matter.

A UI panel 0213 is a hardware configuration corresponding to the UI panel 0103, and is a user interface for performing the overall operation of the image forming apparatus 0102. In the present embodiment, the UI panel 0212 includes a capacitive touch panel.

A paper feed deck I/F 0214 manages communication and control with a paper feed deck 0215. The paper feed deck 0215 is a generic term for hardware configurations corresponding to the paper feed decks 0104 and 0105 and an optional deck 0107. An engine I/F 0216 manages communication and control with a printer engine 0217.

An accessory I/F 0218 is connected to an accessory I/F 0224 via the cable 0109. That is, the image forming apparatus 0102 communicates with the paper discharging apparatus 0108 via the accessory I/Fs 0218 and 0224.

### ● Paper Discharging Apparatus

The CPU 0220 manages control and computation of each unit in the paper discharging apparatus 0108 via a system bus 0225, and execution of a program to be stored in the storage unit 0222 and loaded into the RAM 0221.

The RAM 0221 is a type of general volatile storage apparatus directly accessible from the CPU 0220, and is used as a work area or another temporary data storage area of the CPU 0220.

The storage unit 0222 also functions as a temporary storage area and a work memory during operation of the paper discharging apparatus.

A paper discharge unit 0223 manages a paper discharge operation to a paper discharging tray included in the paper discharging apparatus 0108 and monitor and control of a loading status of each tray.

An accessory I/F 0224 is connected to an accessory I/F 0218 via the cable 0109. That is, the paper discharging apparatus 0108 communicates with the image forming apparatus 0102 via the accessory I/Fs 0224 and 0218.

### ● Software Configuration

FIG. 3 is a software block diagram illustrating a connection system of each control unit of the client computer 0101, the image forming apparatus 0102, and the paper discharging apparatus 0108. Note that some of the blocks of the hardware are also included.

The client computer 0101 includes a data management unit 0301, a data request unit 0302, a UI control unit 0303, an image data input reception unit 0304, an image alignment unit 0305, an object information analysis unit 0306, and a color space determination unit 0307.

Furthermore, the client computer 0101 includes an object separation image data generation unit 0308, a bitmap image data generation unit 0309, a signal value extraction unit 0310, a color conversion unit 0311, a color conversion table creation unit 0312, and a color profile creation unit 0313. These software functional blocks are realized by executing a program stored in the RAM 0202 or the storage unit 0203 of the client computer 0101 and cooperating with hardware. The program is executed by the CPU 0201 of the client computer 0101.

Hereinafter, the processing of each functional block (hereinafter, referred to as a control unit) illustrated in FIG. 3 included in the client computer 0101 will be described. Note that if there is data that is lacking when each control unit attempts to execute processing on its own, the lacking data is compensated by mutually executing the processing of each control unit.

The data management unit 0301 manages, in the client computer 0101, data necessary when each control unit executes processing, such as a color profile (described later), document data, and color sample scan data. When receiving a request for data from each control unit, the data management unit 0301 transfers, to each control unit, data managed in the data management unit 0301, the RAM 0202, or the storage unit 0203. Furthermore, when receiving storage of data from each control unit, the data management unit 0301 manages the received data in the data management unit 0301, the RAM 0202, or the storage unit 0203.

The data request unit 0302 acquires a color profile saved in the RAM 0209 or the storage unit 0210 of the image forming apparatus 0102. The data request unit 0302 stores the color profile and data acquired from the image forming apparatus 0102 into the data management unit 0301, the RAM 0202, or the storage unit 0203.

The UI control unit 0303 performs control for displaying a UI onto the display unit 0205. The UI control unit 0303 performs control for displaying the UI based on an input signal from the input unit 0206.

The image data input reception unit 0304 is an input reception unit that receives, from the user, input of document data desired to print by reproducing the color of the color sample by the image forming apparatus 0102. The image data input reception unit 0304 is an input reception unit that receives an input of color sample scan data obtained by scanning, with an image scanner, a color sample image from the user. The color sample scan data may be saved in a predetermined storage location in advance, or may be obtained by being scanned with the image scanner. Furthermore, the image data input reception unit 0304 stores received document data and color sample scan data into the data management unit 301.

The image alignment unit 0305 aligns alignment reference image data and alignment target image data designated by the CPU 0201. The alignment reference image data is image data serving as a reference for alignment, and is document data, for example. The alignment target image data is image data serving as a target for image processing so as to perform alignment with reference to the alignment reference image data, and is color sample scan data, for example.

The image alignment unit 0305 detects features of the respective image data of the alignment reference image data and the alignment target image data, and matches the features of the respective image data. Thereafter, the image alignment unit 0305 performs image processing such as affine transformation so that the alignment target image data is aligned with the position of the alignment reference image data. The image alignment unit 0305 generates aligned image data as an image processing result.

Here, document data in the present embodiment will be described. Although there are various data formats of document data, in the present embodiment, the PDF that can include objects having signal values of the plurality of color spaces will be described as a data format of the document data.

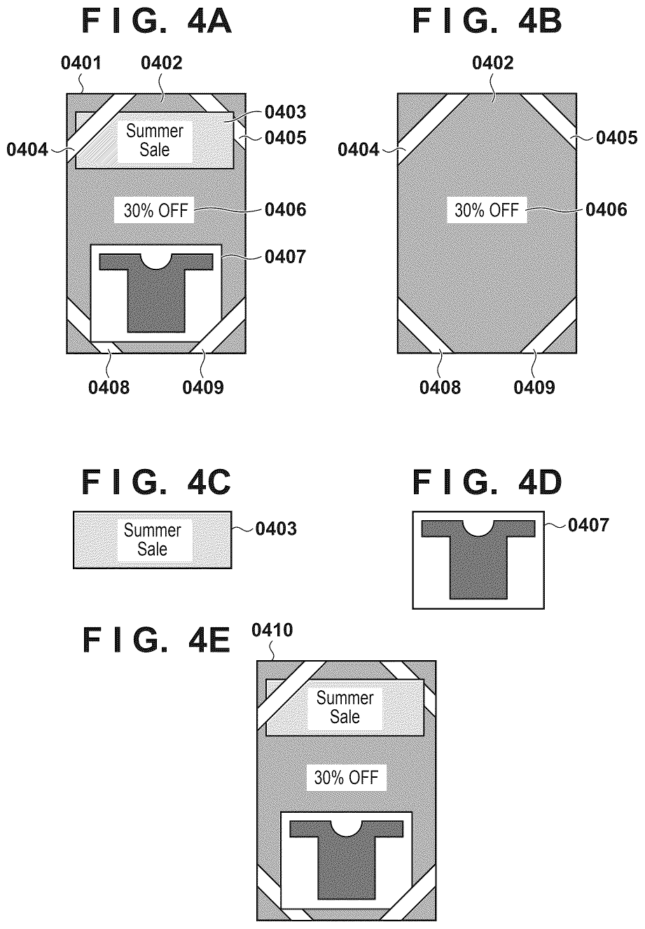

FIG. 4A is an example of document data 0401 including objects having signal values of the plurality of color spaces, and FIGS. 4B to 4D are examples of objects 0402 to 0409 arranged in the document data 0401. The object 0402 is a background and arranged in the lowermost layer of the document data 0401. The objects 0404, 0405, 0408, and 0409 are graphics, and the object 0406 is text. The object 0403 is advertisement banner image data (FIG. 4C), and the object 0407 is image data captured by a camera having an image sensor of RGB (FIG. 4D).

Signal values of the objects 0402, 0404, 0405, 0406, 0408, and 0409 are represented by CMYK, and signal values of the objects 0403 and 0407 are represented by RGB. The overlaying order of the objects 403 to 405 is the objects 405, 403, and 404 in order from the bottom. The overlaying order of the objects 407 to 409 is the objects 408, 407, and 409 in order from the bottom.

FIG. 4E is an example of color sample scan data 0410 acquired by scanning a color sample corresponding to the document data 0401 with the scanner 0212.

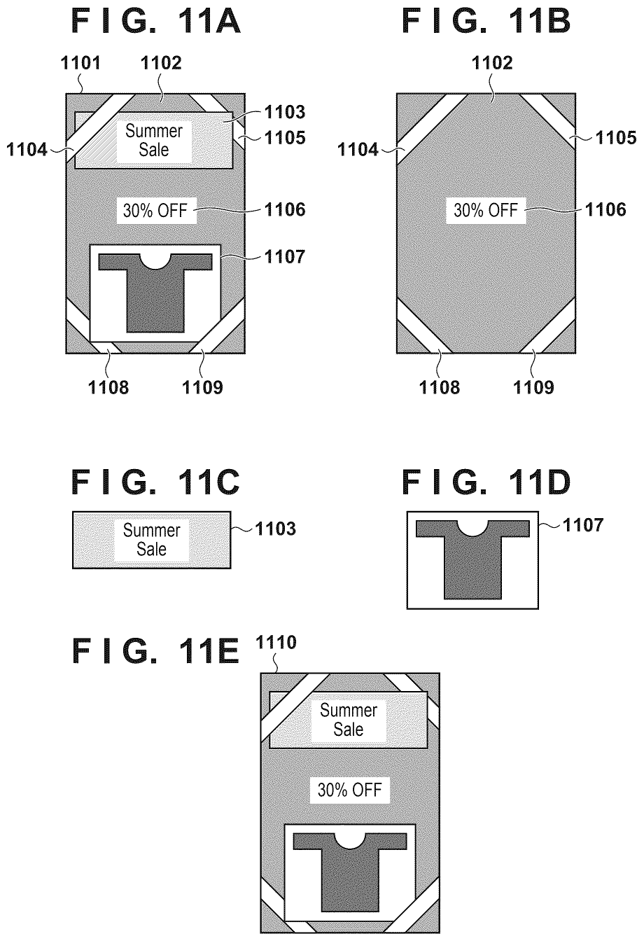

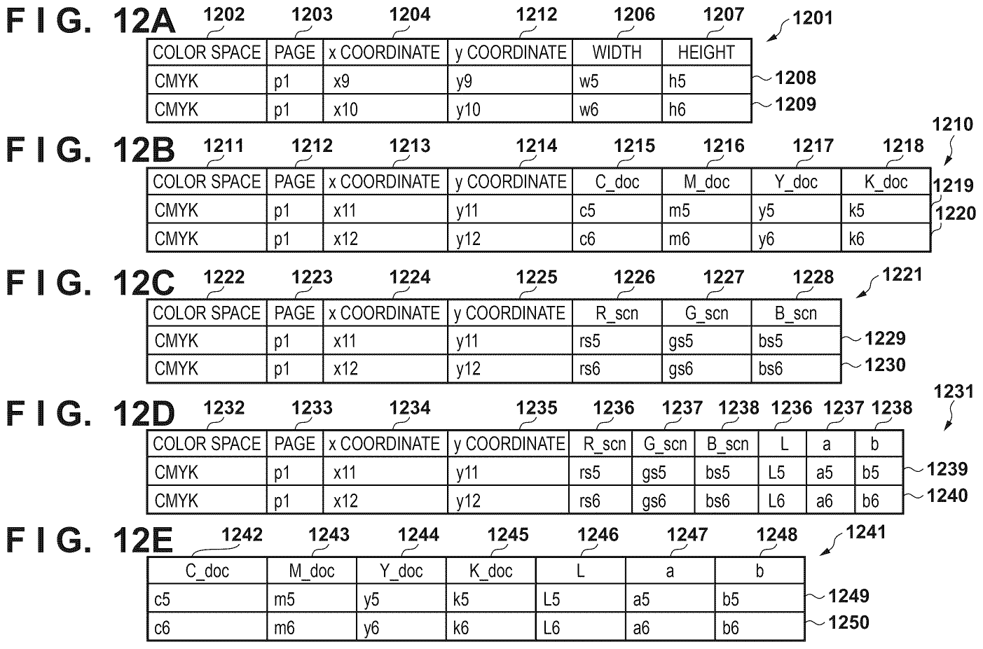

On the other hand, FIG. 11A illustrates document data 1101 based on the document data 0401. FIGS. 11B to 11D are examples of objects 1102 to 1109 arranged in the document data 1101, and signal values of the objects 1102 to 1109 are all represented by CMYK.

FIG. 11E is an example of color sample scan data 1110 acquired by scanning a color sample corresponding to the document data 1101 with the scanner 0212.

The object information analysis unit 0306 analyzes an object arranged in the document data designated by the CPU 0201 to generate object information (described later) based on the analysis result. For example, when the document data 0401 is designated by the CPU 0201, the object information analysis unit 0306 analyzes the objects 0402 to 0409 to generate object information based on the analysis result.

In order to analyze the objects 0402 to 0409 from the document data 0401, it is possible to extract coordinates and a color space in which the objects 0402 to 0409 are arranged on the document data 0401 by analyzing the internal structure of the PDF based on the standard specified in ISO. For example, Adobe Acrobat provided by Adobe, Inc. provides a function of displaying the internal structure of the PDF.

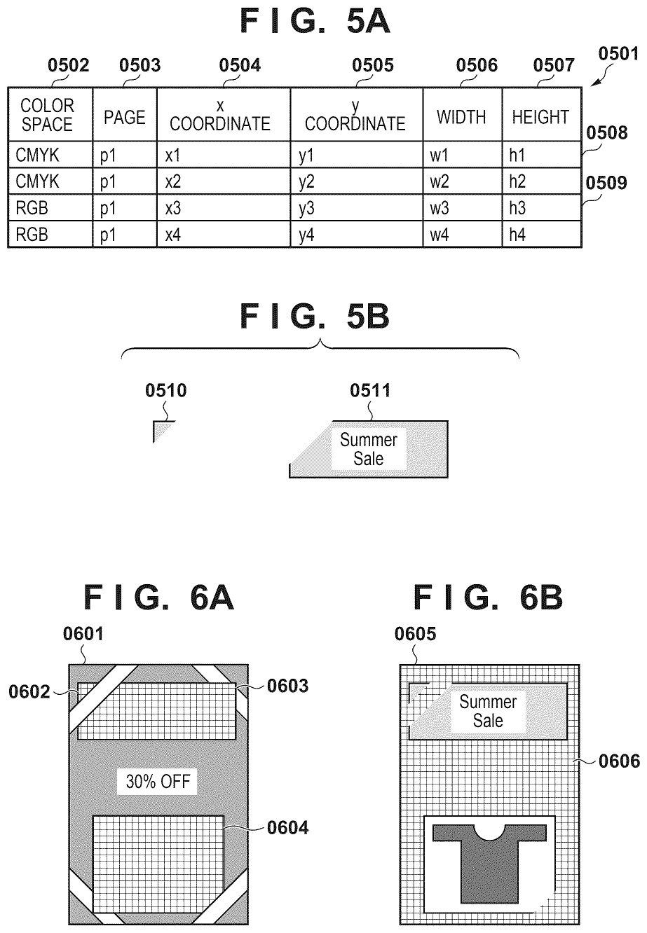

The object information analysis unit 0306 analyzes the objects 0402 to 0409 to generate an area (hereinafter, referred to as a visible area) visible from the uppermost layer of the document data 0401 as object information in consideration of the overlaying order of the objects 0402 to 0409. For example, in FIG. 4A, the object 0404 is arranged on an upper layer of the object 0403, and a part of the object 0403 is not visible from the uppermost layer. Therefore, as a result of analyzing the object 0403, the object information analysis unit 0306 generates, as object information, visible areas 0510 and 0511 illustrated in FIG. 5B.

FIG. 5A illustrates part of object information 0501 generated as a result of analyzing the objects 0402 to 0409 by the object information analysis unit 0306. The object information 0501 includes items 0502 to 0507. The item 0502 represents a color space of a visible area of the object. The item 0503 represents the page number of the visible area in the document data 0401. The item 0504 represents the x coordinate of the visible area in the document data 0401. The item 0505 represents the y coordinate of the visible area in the document data 0401. The item 0506 represents the width of the visible area in the document data 0401. The item 0507 represents the height of the visible area in the document data 0401. Data 0508 indicates an example of a visible area of an object of CMYK, and data 0509 indicates an example of a visible area of an object of RGB.

When determining that it is difficult to represent the visible area by the items 0504 to 0507 (e.g., the visible area has a triangular shape), the object information analysis unit 0306 may divide the visible area into a plurality of pieces of data to hold them as the object information 0501.

In the present embodiment, the object information 0501 is represented in a table format as illustrated in FIG. 5A but may be represented in another format as long as the items 0502 to 0507 and the content thereof can be associated on a one-to-one basis, such as a JSON format. Some items in the items 0502 to 0507 may be combined into one item. Furthermore, if the document data 0401 includes only one page, the item 0503 may be omitted.

When the document data 1101 is designated by the CPU 0201, the object information analysis unit 0306 analyzes the objects 1102 to 1109 to generate object information 1201 (FIG. 12A). FIG. 12A illustrates part of the object information 1201 generated as a result of analyzing the objects 1102 to 1109 by the object information analysis unit 0306. The object information 1201 includes items 1202 to 1207. Since the items 1202 to 1207 are similar to the items 0502 to 0507, description thereof is omitted. Data 1208 and 1209 represent an example of a visible area of an object of CMYK.

The color space determination unit 0307 determines the number of color spaces of the objects arranged in the document data designated by the CPU 0201. For example, when the document data 0401 is designated by the CPU 0201, the color space determination unit 0307 determines that there are two color spaces with reference to the item 0502 of the object information 0501 corresponding to the document data 0401. When the document data 1101 is designated by the CPU 0201, the color space determination unit 0307 determines that there is one color space with reference to the item 1202 of the object information 1201 corresponding to the document data 1101.

Based on the document data and the object information designated by the CPU 0201, the object separation image data generation unit 0308 separates the visible area for each color space from the document data designated by the CPU 0201 to generate object separation image data. For example, when the document data 0401 and the object information 0501 are designated by the CPU 0201, the object separation image data generation unit 0308 separates the visible area for each color space from the document data 0401 based on the object information 0501. Thereafter, the object separation image data generation unit 0308 generates the object separation image data. The object separation image data is data in which an object included in the document data is divided for each color space (color system).

FIGS. 6A and 6B are examples of object separation image data 0601 and 0605 generated by the object separation image data generation unit 0308. The object separation image data 0601 illustrated in FIG. 6A is image data of a visible area of an object of CMYK. Areas 0602 to 0604 are visible areas of objects of RGB, and therefore represent absence of any object in a lattice pattern. The object separation image data 0605 illustrated in FIG. 6B is image data of a visible area of an object of RGB. An area 0606 is a visible area of an object of CMYK, and therefore represents absence of any object in a lattice pattern.

The bitmap image data generation unit 0309 performs rasterization based on the image data designated by the CPU 0201 to generate bitmap image data. For example, when the object separation image data 0601 and 0605 are designated by the CPU 0201, the bitmap image data generation unit 0309 performs rasterization based on the respective object separation image data to generate the bitmap image data. Alternatively, when the document data 1101 is designated by the CPU 0201, the bitmap image data generation unit 0309 performs rasterization based on the document data 1101 to generate the bitmap image data.

Since the object separation image data 0601 is image data of the visible area of the object of CMYK, the bitmap image data generated based on the object separation image data 0601 holds signal values of CMYK pixel by pixel. Since the object separation image data 0605 is image data of the visible area of the object of RGB, the bitmap image data generated based on the object separation image data 0605 holds signal values of RGB pixel by pixel. Furthermore, since the objects 1102 to 1109 of the document data 1101 have signal values of CMYK, the bitmap image data generated based on the document data 1101 holds a signal value of CMYK pixel by pixel.

Hereinafter, the bitmap image data generated by the bitmap image data generation unit 0309 from the object separation image data 0601 or the document data 1101 is referred to as bitmap image data of CMYK. The bitmap image data generated by the bitmap image data generation unit 0309 from the object separation image data 0605 is referred to as bitmap image data of RGB.

The signal value extraction unit 0310 extracts a signal value from the image data designated by the CPU 0201, and stores the extracted signal value and an extracted coordinate on the image data into the data management unit 0301 in association with each other. Specifically, processing of bitmap image data of CMYK and bitmap image data of RGB by the signal value extraction unit 0310 will be described as an example.

The signal value extraction unit 0310 scans a rectangular area having a predetermined size on the image data designated by the CPU 0201 to calculate a mean value of signal values in the rectangular area and treats the calculated mean value as a signal value to be extracted. The signal value extraction unit 0310 associates a starting point coordinate of the rectangular area with the extracted signal value. Note that the signal value to be extracted need not be the mean value in the rectangular area, and may be a median value, a mode value, or the like. The coordinate to be associated need not be the starting point coordinate of the rectangular area, and may be a barycentric coordinate of the rectangular area.

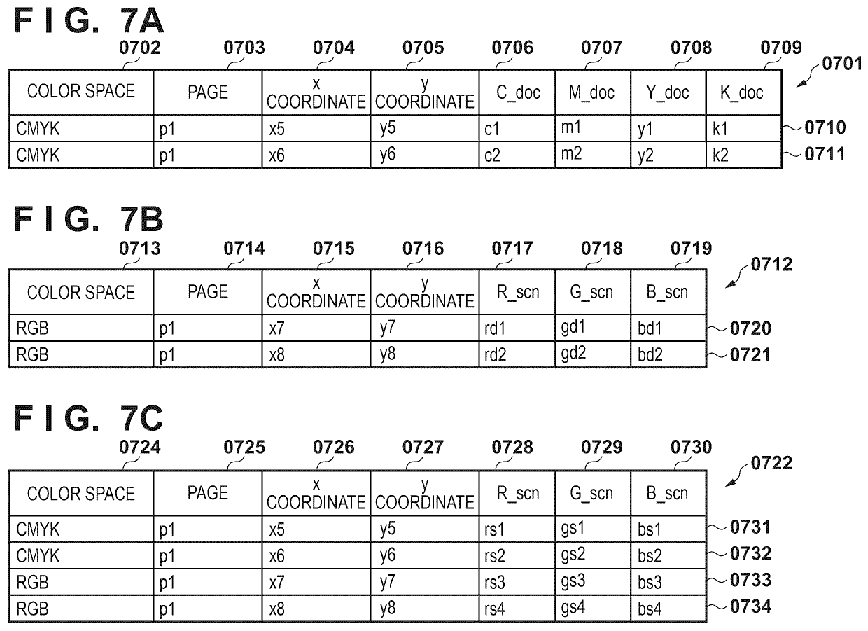

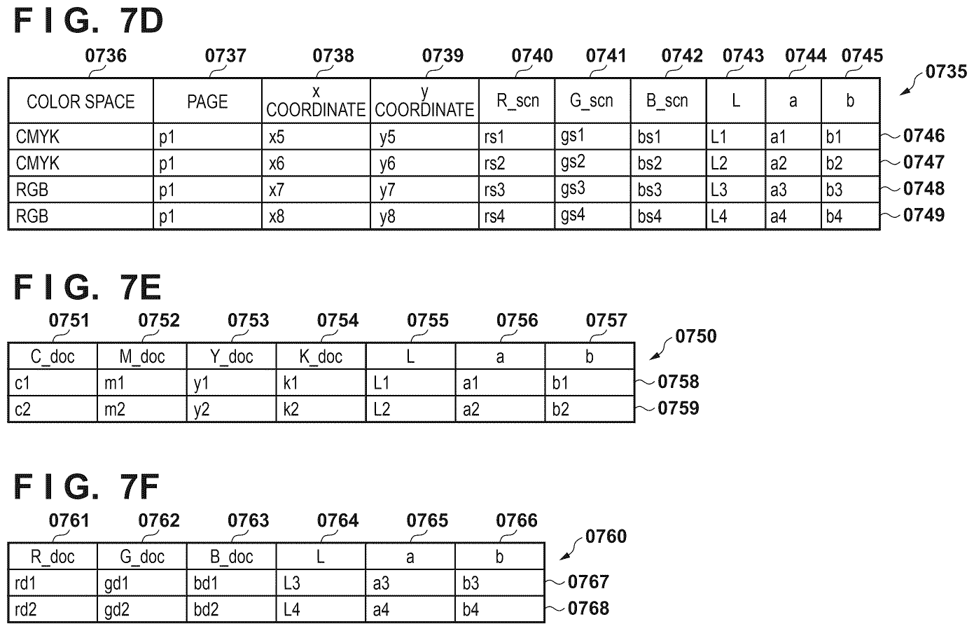

FIG. 7A illustrates a part of an extracted signal value table 0701 to be stored in the data management unit 0301 by the signal value extraction unit 0310 as a processing result by the signal value extraction unit 0310 for the bitmap image data of CMYK.

The extracted signal value table 0701 includes items 0702 to 0709. The item 0702 represents a color space of a signal value extracted by the signal value extraction unit 0310. The item 0703 represents the page number of the signal value extracted by the signal value extraction unit 0310 in the bitmap image data of CMYK. The item 0704 represents the x coordinate of the starting point coordinate of the rectangular area when the signal value extraction unit 0310 extracts the signal value. The item 0705 represents the y coordinate of the starting point coordinate of the rectangular area when the signal value extraction unit 0310 extracts the signal value.

The item 0706 represents a signal value of C (i.e., C component) extracted from the bitmap image data of CMYK by the signal value extraction unit 0310. The item 0707 represents a signal value of M (i.e., M component) extracted from the bitmap image data of CMYK by the signal value extraction unit 0310. The item 0708 represents a signal value of Y (i.e., Y component) extracted from the bitmap image data of CMYK by the signal value extraction unit 0310. The item 0709 represents a signal value of K (i.e., K component) extracted from the bitmap image data of CMYK by the signal value extraction unit 0310. Data 0710 and 0711 indicate examples of processing results of the signal value extraction unit 0310 for the bitmap image data of CMYK.

FIG. 7B illustrates a part of an extracted signal value table 0712 to be stored in the data management unit 0301 by the signal value extraction unit 0310 as a processing result by the signal value extraction unit 0310 for the bitmap image data of RGB.

The extracted signal value table 0712 includes items 0713 to 0719. Since the items 0713 to 0716 are similar to the items 0702 to 0705, description thereof is omitted. The item 0717 represents a signal value of R (i.e., R component) extracted from the bitmap image data of RGB by the signal value extraction unit 0310. The item 0718 represents a signal value of G (i.e., G component) extracted from the bitmap image data of RGB by the signal value extraction unit 0310. The item 0719 represents a signal value of B (i.e., B component) extracted from the bitmap image data of RGB by the signal value extraction unit 0310. Data 0720 and 0721 indicate examples of processing results of the signal value extraction unit 0310 for the bitmap image data of RGB.

On the other hand, based on the object information designated by the CPU 0201, the signal value extraction unit 0310 extracts a signal value from the image data designated by the CPU 0201, and stores the extracted signal value and an extracted coordinate on the image data into the data management unit 0301 in association with each other.

For example, the image alignment unit 0305 generates the aligned image data of the color sample scan data 0410 processed so as to be aligned with the document data 0401 in advance. Thereafter, the signal value extraction unit 0310 receives designation of the aligned image data of the object information 0501 and the color sample scan data 0410 from the CPU 0201. Then, based on the object information 0501, the signal value extraction unit 0310 extracts a signal value from the aligned image data of the color sample scan data 0410, and stores the extracted signal value and an extracted coordinate on the image data into the data management unit 0301 in association with each other.

Specifically, the signal value extraction unit 0310 acquires the x coordinate, the y coordinate, the width, and the height of the visible area for each color space from the object information 0501, and acquires, for each color space, an area corresponding to the visible area on the aligned image data of the color sample scan data 0410. Thereafter, the signal value extraction unit 0310 scans an area corresponding to the visible area on the aligned image data of the color sample scan data 0410 in a rectangular area having a predetermined size, calculates a mean value of signal values in the rectangular area for each color space, and treats the calculated mean value as a signal value to be extracted. The signal value extraction unit 0310 associates a starting point coordinate of the rectangular area when the signal value is extracted with the extracted signal value.

FIG. 7C illustrates a part of an extracted signal value table 0722 to be stored in the data management unit 0301 by the signal value extraction unit 0310 as a processing result by the signal value extraction unit 0310 for the aligned image data of the color sample scan data 0410. The extracted signal value table 0722 includes items 0724 to 0730. The item 0724 represents a color space of a visible area acquired from the object information 0501. Since the items 0725 to 0727 are similar to the items 0703 to 0705 and 0714 to 0716, description thereof is omitted. It is possible to specify the correspondence between the document data and the position (or area) of the aligned color sample scan data by the page number, the X coordinate, and the Y coordinate, and in the document data, it is possible to specify, by the position, the color space of the object visible at the position. Therefore, the color space indicated in the item 0724 is not essential.

Here, the original image of the aligned image data of the color sample scan data 0410 is color sample scan data. Therefore, the color space of the signal value of the aligned image data of the color sample scan data 0410 in the present embodiment is RGB (hereinafter, referred to as scanner-dependent RGB) dependent on the scanner that has scanned the color sample. The item 0728 represents a signal value of R of the scanner-dependent RGB extracted from the aligned image data of the color sample scan data 0410 by the signal value extraction unit 0310. The item 0729 represents a signal value of G of the scanner-dependent RGB extracted from the aligned image data of the color sample scan data 0410 by the signal value extraction unit 0310. The item 0730 represents a signal value of B of the scanner-dependent RGB extracted from the aligned image data of the color sample scan data 0410 by the signal value extraction unit 0310.

Data 0731 and 0732 are examples of visible areas of objects of CMYK among the signal values extracted from the aligned image data of the color sample scan data 0410 by the signal value extraction unit 0310. Data 0733 and 0734 are examples of visible areas of objects of RGB among the signal values extracted from the aligned image data by the signal value extraction unit 0310.

The color conversion unit 0311 converts an apparatus-dependent signal value into an apparatus-independent signal value by using a color profile designated by the CPU 0201. The color conversion unit 0311 converts an apparatus-independent signal value into an apparatus-dependent signal value by using a color profile designated by the CPU 0201.

Here, the apparatus-independent signal value refers to a signal value expressible without depending on an apparatus such as a Lab color space. The apparatus-dependent signal value refers to a signal value expressing a color depending on an apparatus such as RGB or CMYK, and the above-described scanner-dependent RGB is an example.

The color profile includes types such as an input profile and an output profile. In the input profile, a color conversion table of what value should be an apparatus-independent signal value when an apparatus-dependent signal value is input, for example, a color conversion table from a signal value of RGB to the Lab color space is defined. In the output profile, a color conversion table of what value should be an apparatus-dependent signal value when an apparatus-independent signal value is input, for example, a color conversion table from the Lab color space to a signal value of CMYK is defined. In the output profile, a color conversion table similar to that of the input profile, for example, a color conversion table from a signal value of CMYK to the Lab color space is also defined. In general, in the output profile, a color conversion table based on characteristics of a printed matter that can be output by the image forming apparatus 0102 is defined.

The color conversion unit 0311 uses the input profile when converting an apparatus-dependent signal value into an apparatus-independent signal value. The color conversion unit 0311 uses the output profile when converting an apparatus-independent signal value into an apparatus-dependent signal value. Furthermore, the color conversion unit 0311 may store, in the data management unit 0301, the signal value before conversion and the signal value after conversion in association with each other.

FIG. 7D illustrates an example in which the color conversion unit 0311 converts the signal values of the scanner-dependent RGB of the items 0728 to 0730 in the extracted signal value table 0722 into the Lab color space using the scanner profile. The scanner profile is one of input profiles, and is a color conversion table for converting a signal value of the RGB color system read by the scanner 0212 into a signal value of an apparatus-independent Lab color system. The color conversion unit 0311 creates an extracted signal value table 0735 based on the extracted signal value table 0722. The extracted signal value table 0735 includes items 0736 to 0745. Since the items 0736 to 0742 are similar to the items 0724 to 0730, description thereof is omitted.

The item 0743 represents a signal value of L (i.e., L component) converted from signal values of the scanner-dependent RGB of the items 0740 to 0742 into signal values of the Lab color space based on the scanner profile by the color conversion unit 0311. The item 0744 represents a signal value of a (i.e., a component) converted from signal values of the scanner-dependent RGB of the items 0740 to 0742 into signal values of the Lab color space based on the scanner profile by the color conversion unit 0311. The item 0745 represents a signal value of b (i.e., b component) converted from signal values of the scanner-dependent RGB of the items 0740 to 0742 into signal values of the Lab color space based on the scanner profile by the color conversion unit 0311.

Data 0746 to 0749 indicate data that the color conversion unit 0311 converts the signal values of the scanner-dependent RGB of the items 0728 to 0730 of the data 0731 to 0734, respectively, into signal values of the Lab color space.

Note that in the present embodiment, it has been described that the color conversion unit 0311 creates the extracted signal value table 0735 different from the extracted signal value table 0722, but the color conversion unit 0311 may directly insert the items 0743 to 0745 into the extracted signal value table 0722.

The color conversion table creation unit 0312 creates a color conversion table based on the extracted signal value table designated by the CPU 0201. For example, the color conversion table creation unit 0312 creates color conversion tables 0750 (FIG. 7E) and 0760 (FIG. 7F) based on the extracted signal value tables 0701, 0712, and 0735.

FIG. 7E illustrates the color conversion table 0750 representing the signal values in the Lab color space corresponding to the signal values of CMYK extracted from the bitmap image data of CMYK by the signal value extraction unit 0310. The color conversion table creation unit 0312 creates the color conversion table 0750 by collating data in which the items 0702 to 0705 of the extracted signal value table 0701 with the items 0736 to 0739 of the extracted signal value table 0735 match. For example, the color conversion table creation unit 0312 searches the items 0736 to 0739 of the extracted signal value table 0735 for those matching the items 0702 to 0705 of the data 0710 of the extracted signal value table 0701. Next, when determining that the items 0702 to 0705 of the data 0710 match the items 0736 to 0739 of the data 0746, the color conversion table creation unit 0312 associates the items 0706 to 0709 of the data 0710 with the items 0743 to 0745 of the data 0746. Finally, the color conversion table creation unit 0312 inserts the association result, that is, the items 0706 to 0709 of the data 0710 and the items 0743 to 0745 of the data 0746 into the color conversion table 0750 as data 0758.

The color conversion table 0750 includes items 0751 to 0757. The items 0751 to 0754 are similar to the items 0706 to 0709. The items 0755 to 0757 are similar to the items 0743 to 0745. The data 0758 and 0759 indicate a part of the color conversion table 0750.

FIG. 7F illustrates a color conversion table 0760 representing signal values in the Lab color space corresponding to the signal values of RGB extracted from the bitmap image data of RGB by the signal value extraction unit 0310. The color conversion table creation unit 0312 collates the items 0713 to 0716 of the extracted signal value table 0712 with the items 0736 to 0739 of the extracted signal value table 0735. Then, the color conversion table 0760 in which respective signal values are associated with each other is created for data in which the positions (the page numbers and the coordinate values) match each other. Specifically, similarly to the color conversion table 0750, the color conversion table creation unit 0312 creates the color conversion table 0760 in which the items 0717 to 0719 of the extracted signal value table 0712 and the items 0743 to 0745 of the extracted signal value table 0735 are associated with each other.

The color conversion table 0760 includes items 0761 to 0766. The items 0761 to 0763 are similar to the items 0717 to 0718. The items 0764 to 0766 are similar to the items 0743 to 0745. The data 0767 and 0768 indicate a part of the color conversion table 0760.

Here, the items 0751 to 0754 and the items 0761 to 0763 in the color conversion tables 0750 and 0760 are signal values of the document data 0401. The items 0755 to 0757 and the items 0764 to 0766 in the color conversion tables 0750 and 0760 are print target values of the document data 0401. Therefore, the color conversion tables 0750 and 0760 indicate tables for describing what color should be output when the signal values of the document data 0401 are input in the image forming apparatus 0102.

The color profile creation unit 0313 creates a color profile based on the color conversion table designated by the CPU 0201. For example, the color profile creation unit 0313 creates a color matching color profile (hereinafter, referred to as a color matching color profile of CMYK) for conversion from CMYK to the Lab color space based on the color conversion table 0750. The color profile creation unit 0313 creates a color matching color profile (hereinafter, referred to as a color matching color profile of RGB) for conversion from RGB to the Lab color space based on the color conversion table 0760.

Here, it is necessary for the color conversion table used for creation of the color profile to define output signal values (print target values of the document data 0401 in the present embodiment) with respect to input signal values (signal values of the document data 0401 in the present embodiment) that are continuous and at equal intervals. However, the color conversion table created by the color conversion table creation unit 0312 is sometimes defined by output signal values with respect to input signal values that are discrete or local, and such a color conversion table lacks data, and thus a color profile cannot be created.

Therefore, the color profile creation unit 0313 determines whether the data is lacking for creating the color profile for the color conversion table designated by the CPU 0201. Thereafter, the color profile creation unit 0313 derives and compensates for lacking data by interpolation computation, and creates a color profile.

For example, the color profile creation unit 0313 determines whether the items 0751 to 0754 of the color conversion table 0750 are discrete or local input signal values. When determining that the items 0751 to 0754 are discrete or local, the color profile creation unit 0313 determines that the data of the color conversion table 0750 is lacking. Thereafter, the color profile creation unit 0313 compensates for lacking data by performing linear interpolation based on a predetermined initial value (e.g., a color conversion table defined in an output profile based on the image forming apparatus 0102) prepared in advance and the color conversion table 0750. The color profile creation unit 0313 creates a color profile based on the data complemented with the color conversion table 0750.

Note that in the present embodiment, deriving lacking data by linear interpolation has been described as an example, but other interpolation computation methods may be used.

The image forming apparatus 0102 includes a print processing unit 0314, a scanner control unit 0315, and a data management unit 0316, which exist in the RAM 0209 or the storage unit 0210 of the image forming apparatus 0102 and are executed by the CPU 0208. The print processing unit 0314 is called by the CPU 0208 of the image forming apparatus 0102, and performs print processing. The scanner control unit 0315 is called by the CPU 0208 of the image forming apparatus 0102, and scans a printed matter by using the scanner 0212. The data management unit 0316 is called by the CPU 0208 of the image forming apparatus 0102, and performs data management of the configuration and capability information of the image forming apparatus 0102, print jobs, scan data, and color profiles.

The paper discharging apparatus 0108 includes a post-processing control unit 0317. The post-processing control unit 0317 exists in the RAM 0221 or the storage unit 0222 of the paper discharging apparatus 0108, and is executed by the CPU 0220. The post-processing control unit 0317 is called by the CPU 0220 of the paper discharging apparatus 0108, and discharges the printed sheet to the tray.

### ● Creation of Color Matching Color Profile

A method of creating, for each color space, a color matching color profile for reproducing the same color as the color sample to perform print in a case where the document data 0401 includes objects having signal values of the plurality of color spaces in the present embodiment will be described with reference to FIGS. 8A to 12E. That is, a creation method of the color conversion table will be described.

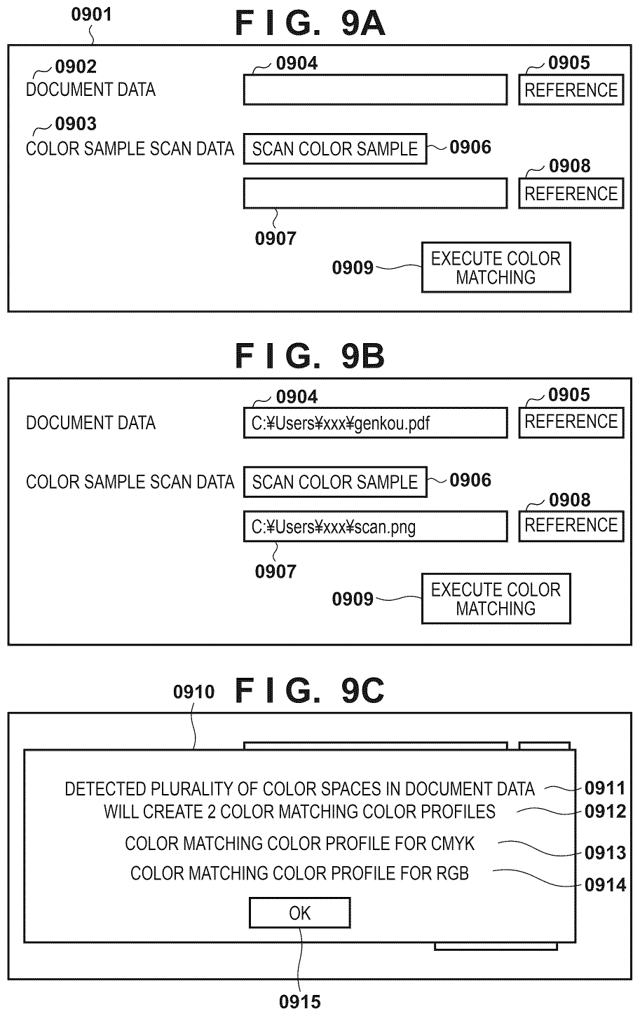

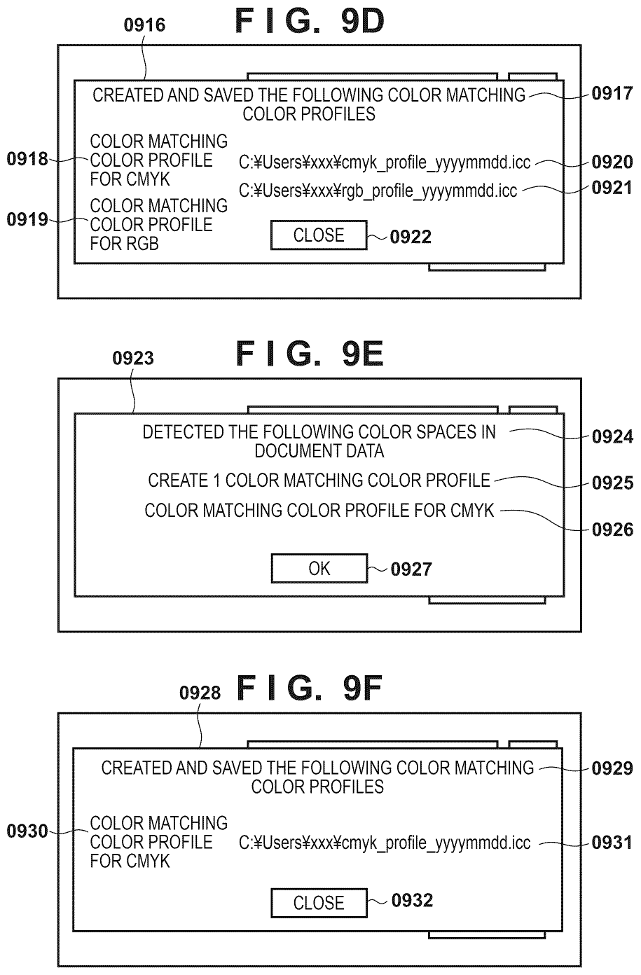

FIGS. 8A and 8B are flowcharts of processing in which the CPU 0201 determines a color space included in the document data 0401 or 1101 and creates, for each color space, a color matching color profile for reproducing the same color as the color sample. This processing is realized by the CPU 0201 executing a program stored in the ROM 0208 or the storage unit 0210. When receiving a request for creating a color matching color profile for reproducing the document data 0401 with the same color as the color sample based on the document data 0401 and the color sample scan data 0410, the CPU 0201 starts the processing of the flowcharts of FIGS. 8A and 8B. Alternatively, when receiving a request for creating a color matching color profile for reproducing the same color as the color sample corresponding to the document data 1101, the CPU 0201 starts the processing of the flowcharts of FIGS. 8A and 8B. Upon starting the processing of the flowcharts of FIGS. 8A and 8B, the CPU 0201 displays a window 0901 illustrated in FIG. 9A onto the display unit 0205 by the UI control unit 0303 of the client computer 0101.

The window 0901 is an example of a UI for creating a color matching color profile for reproducing the same color as the color sample from the document data 0401 or 1101 and the color sample scan data 0410 or 1110. A text 0902 indicates an item for setting the document data 0401 or 1101. A text 0903 indicates an item for setting the color sample scan data 0410 or 1110.

A textbox 0904 is a textbox for inputting a file path in which the document data 0401 or 1101 to be used for color matching color profile creation is arranged. The CPU 0201 detects input by a keyboard from the input unit 0206 to set the file path input from the keyboard in the textbox 0904. Alternatively, the CPU 0201 detects drag and drop of the document data 0401 or 1101 from the input unit 0206 to the textbox 0904 with a mouse to read the file path in which the document data 0401 or 1101 is arranged. Thereafter, the CPU 0201 may display the read file path in the textbox 0904.

A button 0905 is a button for displaying a file selection dialog for setting the document data 0401 or 1101 to be used for color matching color profile creation. The CPU 0201 detects press of the button 0905 to display a file selection dialog for setting the document data 0401 or 1101.

A button 0906 is a button for scanning, with the scanner 0212, the printed matter set in the scanner 0106 to generate scan data, and setting the generated scan data as image data to be used for color matching color profile creation.

A textbox 0907 is a textbox for inputting a file path in which the color sample scan data 0410 or 1110 to be used for color matching color profile creation is arranged. The textbox 0907 has a function similar to that of the textbox 0904.

A button 0908 is a button for displaying a file selection dialog for setting the color sample scan data 0410 or 1110 to be used for color matching color profile creation. The button 0908 has a function similar to that of the button 0905.

A button 0909 is a button for executing color matching color profile creation by using the document data 0401 or 1101 and the color sample scan data 0410 or 1110 set by the user. The CPU 0201 detects press of the button 0909 to execute color matching color profile creation by using the document data 0401 and the color sample scan data set by the user.

Hereinafter, the processing of the flowchart of FIG. 8 will be described. Note that the order of processing and the configuration of processing of the flowchart described in the present embodiment are merely examples, and the order of processing of the flowchart may be reversed or the configuration of processing may be partially skipped.

In S801, the CPU 0201 displays the window 0901, and receives, by the image data input reception unit 0304 of the client computer 0101, the input of the document data 0401 and the color sample scan data 0410 to be used for color matching color profile creation. Alternatively, by the image data input reception unit 0304 of the client computer 0101, the CPU 0201 receives the input of the document data 1101 and the color sample scan data 1110 to be used for color matching color profile creation. For example, the CPU 0201 receives the input of the document data 0401 or 1101 and the color sample scan data 0410 or 1110 by the input to the textboxes 0904 and 0907. Alternatively, the CPU 0201 detects drag and drop to the textboxes 0904 and 0907 to receive the input of the document data 0401 or 1101 and the color sample scan data 0410 or 1110. Alternatively, the CPU 0201 detects press of the buttons 0905 and 0908 to display the file selection dialog and receive the input of the document data 0401 or 1101 and the color sample scan data 0410 or 1110.

Here, in a case where the user does not have the color sample scan data 0410 or 1110, the CPU 0201 detects that the button 0906 is pressed and the color sample corresponding to the document data 0401 or 1101 is set in the scanner 0106. Thereafter, the CPU 0201 scans the color sample corresponding to the document data 0401 or 1101 with the scanner 0212 to generate color sample scan data 0410 or 1110. The CPU 0201 may use, for color matching color profile creation, the color sample scan data 0410 or 1110 generated by the scanner 0212.

FIG. 9B is an example of a UI indicating a result of the CPU 0201 having received the input of the document data and the color sample scan data in S801. The CPU 0201 displays the document data 0401 or 1101 and the color sample scan data 0410 or 1110 for which the input is received in S801 in the textboxes 0904 and 0907.

Next, in S802, the CPU 0201 determines whether press of the color matching execution button 0909 is detected. When detecting press of the color matching execution button 0909, the CPU 0201 executes the processing of S803. On the other hand, when not detecting press of the color matching execution button 0909, the CPU 0201 executes the processing of S802 again.

Next, in S803, by the image alignment unit 0305 of the client computer 0101, the CPU 0201 aligns the document data 0401 and the color sample scan data 0410 for which the input is received in S801. Alternatively, by the image alignment unit 0305 of the client computer 0101, the CPU 0201 aligns the document data 1101 and the color sample scan data 1110 for which the input is received in S801.

Specifically, the CPU 0201 performs alignment with the document data 0401 or 1101 as alignment reference image data and the color sample scan data 0410 or 1110 as alignment target image data. Thereafter, the CPU 0201 generates the aligned image data of the color sample scan data 0410 or aligned image data of the color sample scan data 1110 subjected to image processing on the color sample scan data 0410 or 1110.

In alignment, for example, the color sample scan data 0410 or 1110 is translated by a predetermined distance in respective directions of up, down, left, and right, and, in addition, is rotated by a predetermined angle in respective directions of left and right to obtain a correlation value with the document data 0401 or 1101. Then, the color sample scan data 0410 or 1110 when the correlation is maximum may be the data after alignment. That is, alignment is performed for translation component and the rotation component, respectively. As the correlation value, a sum of squares of differences of corresponding pixel values included in, for example, the entire image or one or a plurality of partial areas can be used. In this case, the minimum correlation value indicates the maximum correlation. Note that when such a correlation is established, an object represented in CMYK included in document data may be temporarily converted into a bitmap of RGB using a given input/output profile before color matching, and then the correlation value may be obtained. Of course this is an example, and a learned model that outputs color sample scan data after alignment with the document image data and the color sample scan data as input may be created by, for example, machine learning or the like, and alignment may be performed using the learned model.

Next, in S804, by the object information analysis unit 0306 of the client computer 0101, the CPU 0201 analyzes the objects 0402 to 0409 arranged in the document data 0401 and generates the object information 0501. Alternatively, by the object information analysis unit 0306 of the client computer 0101, the CPU 0201 analyzes the objects 1102 to 1109 arranged in the document data 1101 and generates the object information 1201.

Next, in S805, by the color space determination unit 0307 of the client computer 0101, the CPU 0201 determines the number of color spaces of the objects 0402 to 0409 of the document data 0401. Alternatively, by the color space determination unit 0307 of the client computer 0101, the CPU 0201 determines whether there are a plurality of color spaces of the objects 1102 to 1109 of the document data 1101. This determination may be made by referring to the items 0502 and 1202 included in the object information 0501, the object information 1201, and the like, for example, and referring to the color spaces of the respective objects to count the number thereof. If there are a plurality of color spaces, the processing branches to S806, and otherwise branches to S812.

In the examples illustrated in FIGS. 5A and 5B, by the color space determination unit 0307 of the client computer 0101, the CPU 0201 determines that there are a plurality of color spaces (two color spaces) of the objects 0402 to 0409 of the document data 0401. The CPU 0201 executes the processing of S806 based on the determination result (S805: Y).

On the other hand, by the color space determination unit 0307 of the client computer 0101, the CPU 0201 determines that the number of color spaces of the objects 1102 to 1109 in the document data 1101 is not a plurality (there is one color space). The CPU 0201 executes the processing of S812 based on the determination result (S805: N).

Next, in S806, by the UI control unit 0303 of the client computer 0101, the CPU 0201 displays the color matching color profile for each color space to be created based on the object information 0501 corresponding to the document data 0401 and the determination result of S805. For example, the CPU 0201 determines that it is necessary to create two color matching color profiles of a color matching color profile of CMYK and a color matching color profile of RGB based on the item 0502 of the object information 0501 and the determination result of S805. The CPU 0201 displays a dialog 0910 illustrated in FIG. 9C based on the determination result. The dialog 0910 includes the number of color profiles to be created (i.e., the number of color spaces) and character strings indicating the respective color spaces.

The dialog 0910 is an example of a UI for indicating what color matching color profile the CPU 0201 creates. A text 0911 is a text indicating the determination result of S805. A text 0912 is a text indicating the number of color matching color profiles to be created by the CPU 0201 based on the determination result of S805. In the present embodiment, it is indicated that the CPU 0201 creates two color matching color profiles of a color matching color profile of CMYK and a color matching color profile of RGB.

A text 0913 is a text indicating creating a color matching color profile of CMYK. A text 0914 is a text indicating creating a color matching color profile of RGB.

A button 0915 is a button for prompting the user to confirm the content of the dialog 0910 and closing the dialog 0910 to proceed to the next processing. For example, the CPU 0201 may detect press of the button 0915 to execute the next processing.

Next, in S807, the CPU 0201 extracts respective signal values for each color space from the aligned image data of the document data 0401 and the color sample scan data 0410 based on the object information 0501.

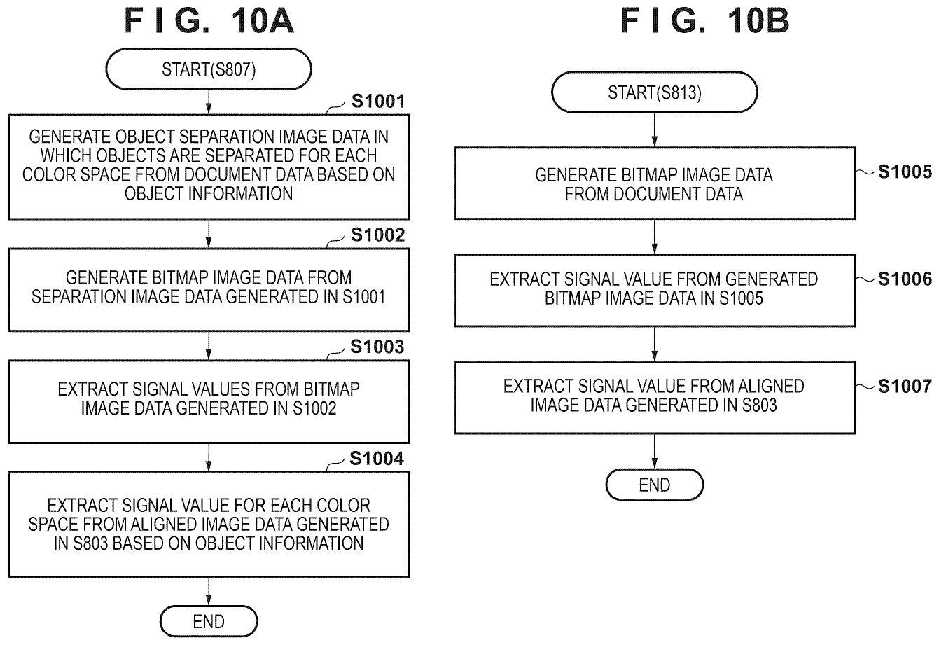

Here, the flow of the processing of S807 will be specifically described with reference to the flowchart of FIG. 10A. When starting the processing of S807, the CPU 0201 starts the processing of the flowchart of FIG. 10A.

First, in S1001, by the object separation image data generation unit 0308 of the client computer 0101, the CPU 0201 generates object separation image data from the document data 0401 based on the object information 0501. The object separation image data to be generated is image data in which objects are separated for each color space used in the document data. The CPU 0201 generates the object separation image data 0601 and 0605 as a processing result of S1001.

Next, in S1002, by the bitmap image data generation unit 0309 of the client computer 0101, the CPU 0201 generates bitmap image data from the object separation image data of the respective color spaces generated in S1001. For example, the CPU 0201 generates bitmap image data of CMYK from the object separation image data 0601, and generates bitmap image data of RGB from the object separation image data 0605.

Next, in S1003, by the signal value extraction unit 0310 of the client computer 0101, the CPU 0201 extracts signal values from respective bitmap image data for each color space generated in S1002 to generate an extracted signal value table. For example, by the signal value extraction unit 0310 of the client computer 0101, the CPU 0201 extracts a signal value from the bitmap image data of CMYK generated in S1002 and generates the extracted signal value table 0701. By the signal value extraction unit 0310 of the client computer 0101, the CPU 0201 extracts a signal value from the bitmap image data of RGB generated in S1002 and generates the extracted signal value table 0712.

Next, in S1004, by the signal value extraction unit 0310 of the client computer 0101, the CPU 0201 extracts a signal value for each color space from the aligned image data generated in S803 based on the object information 0501. Furthermore, the CPU 0201 generates an extracted signal value table from the extracted signal value. For example, by the signal value extraction unit 0310 of the client computer 0101, the CPU 0201 extracts a signal value for each color space from the aligned image data of the color sample scan data 0410 based on the object information 0501. Thereafter, by the signal value extraction unit 0310 of the client computer 0101, the CPU 0201 generates the extracted signal value table 0722 as an extracted signal value. At this time, both pages and areas are selected such that the area of the object separation image data for each color space serving as the target of extracting the signal value corresponds to the area of the aligned image data of the color sample scan data 0410. Since the area of the object separation image data is determined for each color space, the area of the object separation image data may be determined first, and the corresponding page and area may be specified from the aligned image data of the color sample scan data 0410.

The description returns to the flowchart of FIG. 8. In S808, by the color conversion unit 0311 of the client computer 0101, the CPU 0201 converts the signal value of the aligned image data of the color sample scan data 0410 extracted in S807 into an apparatus-independent signal value. For example, by the color conversion unit 0311 of the client computer 0101, the CPU 0201 converts the signal values of the items 0728 to 0730 of the extracted signal value table 0722 into apparatus-independent signal values using the scanner profile. Thereafter, the CPU 0201 associates the signal values of the items 0728 to 0730 with the converted apparatus-independent signal values to generate the extracted signal value table 0735.

Next, in S809, by the color conversion table creation unit 0312 of the client computer 0101, the CPU 0201 creates the color conversion table for each color space. For example, by the color conversion table creation unit 0312 of the client computer 0101, the CPU 0201 collates the extracted signal value tables 0701 and 0712 for each color space of the document data with the extracted signal value table 0735 of the color sample scan data. Then, the color conversion tables 0750 and 0760 for each color space are created from the signal values of the document data and the apparatus-independent signal values obtained from the color sample scan data corresponding to the page number and the coordinates thereof. That is, the color conversion table 0750 and the color conversion table 0760 are tables in which the signal values of the first area belonging to the respective objects in the color space included in the document data and the signal values of the second area corresponding to the first area in the color sample scan data are associated with each other. Here, the signal values of the first area and the second area are, for example, mean values of signal values of pixels belonging to the respective areas. The signal value of the second area is a value in which, for example, the signal value of RGB of the color sample scan data is converted into a signal value in an apparatus-independent color space, in this example, a signal value in the Lab color space.

Next, in S810, by the color profile creation unit 0313 of the client computer 0101, the CPU 0201 creates a color matching color profile for each color space based on the color conversion tables 0750 and 0760 created in S809. For example, by the color profile creation unit 0313 of the client computer 0101, the CPU 0201 creates a color matching color profile of CMYK by interpolating signal values or the like based on the color conversion table 0750. By the color profile creation unit 0313 of the client computer 0101, the CPU 0201 creates a color matching color profile of RGB by interpolating signal values or the like based on the color conversion table 0760.

Next, in S811, the CPU 0201 saves, in a predetermined place, the color matching color profile created in S810. When saving the color matching color profile created in S810 in the predetermined place, the CPU 0201 displays a dialog 0916 illustrated in FIG. 9D by the UI control unit 0303 of the client computer 0101. The dialog 0916 includes a text indicating the color space to be color-converted by the created color profile and a text indicating the location of the created color profile.

The dialog 0916 is an example of a UI for indicating where the CPU 0201 has saved the color matching color profile created in S810.

A text 0917 is a text indicating that the color matching color profile created in S810 has been saved. A text 0918 is a text indicating being an item of a color matching color profile of CMYK. A text 0919 is a text indicating being an item of a color matching color profile of RGB.

A text 0920 is a text indicating a save destination file path of the color matching color profile of CMYK. A text 0921 is a text indicating a save destination file path of the color matching color profile of RGB. A button 0922 is a button for prompting the user to confirm the content of the dialog 0916 and closing the dialog 0916. For example, the CPU 0201 may detect press of the button 0922 to close the dialog 0916 and end the processing of the flowchart of FIG. 8.

Hereinafter, the processing of S812 to S817 executed when the CPU 0201 determines in S805 that there is one color space of the objects 1102 to 1109 of the document data 1101 (S805: N) will be described.

In S812, similarly to S806, the CPU 0201 displays the color matching color profile to be created based on the object information 1201 corresponding to the document data 1101 and the determination result of S805. For example, the CPU 0201 determines that it is necessary to create one color matching color profile of only a color matching color profile of CMYK based on the item 1202 of the object information 1201 and the determination result of S805. The CPU 0201 displays a dialog 0923 illustrated in FIG. 9E based on the determination result.

The dialog 0923 is a dialog similar to the dialog 0910. Texts 0924 to 0926 are text similar to the texts 0911 to 0913. In the present embodiment, a text 0925 indicates that the CPU 0201 creates one color matching color profile of only a color matching color profile of CMYK. The button 0927 is a button similar to the button 0915.

Next, in S813, the CPU 0201 extracts signal values from the aligned image data of the document data 1101 and the color sample scan data 1110, respectively.

Here, the flow of the processing of S813 will be specifically described with reference to the flowchart of FIG. 10B. When starting the processing of S813, the CPU 0201 starts the processing of the flowchart of FIG. 10B.

First, in S1005, by the bitmap image data generation unit 0309 of the client computer 0101, the CPU 0201 generates bitmap image data of CMYK from the document data 1101.

Next, in S1006, by the signal value extraction unit 0310 of the client computer 0101, the CPU 0201 extracts a signal value from the bitmap image data of CMYK generated in S1005. For example, by the signal value extraction unit 0310 of the client computer 0101, the CPU 0201 extracts a signal value from the bitmap image data of CMYK generated in S1005 to generate an extracted signal value table 1210 (FIG. 12B). Note that here, a case where the color space of the object of the document data is only CMYK is taken as an example, but also in another color space such as RGB, the signal value is similarly extracted from the bitmap image data, and an extracted signal value table of the color space is created.

FIG. 12B illustrates a part of an extracted signal value table 1210 to be stored in the data management unit 0301 by the signal value extraction unit 0310 as a processing result by the signal value extraction unit 0310 for the bitmap image data of CMYK generated in S1005. The extracted signal value table 1210 includes items 1211 to 1218. Since the items 1211 to 1218 are similar to the items 0702 to 0709 of the extracted signal value table 0701, description thereof is omitted. Note that since it is clear from the determination result of S805 that there is one color space of the signal values of the objects 1102 to 1109 of the document data 1101, the item 1211 may be omitted. Data 1219 and 1220 indicate examples of processing results of the signal value extraction unit 0310 for the bitmap image data of CMYK generated in S1005.

Next, in S1007, by the signal value extraction unit 0310 of the client computer 0101, the CPU 0201 extracts a signal value from the aligned image data of the color sample scan data 1110 generated in S803. By the signal value extraction unit 0310 of the client computer 0101, the CPU 0201 generates an extracted signal value table 1221 (FIG. 12 C) as the extracted signal value.

FIG. 12 C illustrates a part of an extracted signal value table 1221 to be stored in the data management unit 0301 by the signal value extraction unit 0310 as a processing result by the signal value extraction unit 0310 for the aligned image data of the color sample scan data 1110. The extracted signal value table 1221 includes items 1222 to 1228. Since the items 1222 to 1228 are similar to the items 0724 to 0730, description thereof is omitted. Note that since it is clear from the determination result of S805 that there is one color space of the signal values of the objects 1102 to 1109 of the document data 1101 corresponding to the aligned image data of the color sample scan data 1110, the item 1222 may be omitted. Data 1229 and 1230 indicate examples of processing results of the signal value extraction unit 0310 for the aligned image data of the color sample scan data 1110.

The description returns to the flowchart of FIG. 8. In S814, similarly to S808, by the color conversion unit 0311 of the client computer 0101, the CPU 0201 converts the signal value of the aligned image data of the color sample scan data 1110 extracted in S813 into an apparatus-independent signal value. For example, by the color conversion unit 0311 of the client computer 0101, the CPU 0201 converts the signal values of the items 1226 to 1228 of the extracted signal value table 1221 into apparatus-independent signal values using the scanner profile. Thereafter, the CPU 0201 associates the signal values of the items 1226 to 1228 with the converted apparatus-independent signal values to generate an extracted signal value table 1231 (FIG. 12D).

FIG. 12D illustrates an example in which the color conversion unit 0311 converts the signal values of the scanner-dependent RGB of the items 1226 to 1228 in the extracted signal value table 1221 into the Lab color space using the scanner profile. By the color conversion unit 0311 of the client computer 0101, the CPU 0201 creates the extracted signal value table 1231 based on the extracted signal value table 1221.

The extracted signal value table 1231 includes items 1232 to 1238. Since the items 1232 to 1238 are similar to the items 1222 to 1228 of the extracted signal value table 1221, description thereof is omitted. Since the items 1236 to 1238 are similar to the items 0743 to 0745 of the extracted signal value table 0735, description thereof is omitted. Data 1239 and 1240 indicate data that the color conversion unit 0311 converts the signal values of the scanner-dependent RGB of the items 1226 to 1228 of the data 1229 to 1230, respectively, into signal values of the Lab color space.

Next, in S815, by the color conversion table creation unit 0312 of the client computer 0101, the CPU 0201 creates the color conversion table. For example, by the color conversion table creation unit 0312 of the client computer 0101, the CPU 0201 collates the extracted signal value tables 1210 and 1231. Then, a color conversion table 1241 (FIG. 12E) is created from the signal values of the document data and the apparatus-independent signal values obtained from the color sample scan data corresponding to the page number and the coordinates thereof.

FIG. 12E illustrates a part of the color conversion table 1241 created by the color conversion table creation unit 0312. The color conversion table creation unit 0312 creates the color conversion table 1241 by collating data in which the items 1211 to 1214 of the extracted signal value table 1210 with the items 1232 to 1235 of the extracted signal value table 1231 match.

The color conversion table 1241 includes items 1242 to 1248. Since the items 1242 to 1245 are similar to the items 1215 to 1218 of the extracted signal value table 1210, description thereof is omitted. Since the items 1246 to 1248 are similar to the items 1236 to 1238 of the extracted signal value table 1231, description thereof is omitted. The data 1249 and 1250 indicate a part of the color conversion table 1241. The color conversion table 1241 is a table for only one single color space of the object of the document data, in this example, color conversion from CMYK to Lab. Similarly to the color conversion table 0750, the color conversion table 1241 is a table in which the signal values of the first area belonging to the objects in the color space included in the document data and the signal values of the second area corresponding to the first area in the color sample scan data are associated with each other. Here, the signal values of the first area and the second area are, for example, mean values of signal values of pixels belonging to the respective areas. The signal value of the second area is a value in which, for example, the signal value of RGB of the color sample scan data is converted into a signal value in an apparatus-independent color space, in this example, a signal value in the Lab color space.

Next, in S816, similarly to S810, by the color profile creation unit 0313 of the client computer 0101, the CPU 0201 creates a color matching color profile of CMYK based on the color conversion table 1241 created in S815.

Finally, in S817, similarly to S811, the CPU 0201 saves, in a predetermined place, the color matching color profile created in S816. When saving the color matching color profile created in S816 in the predetermined place, the CPU 0201 displays a dialog 0928 illustrated in FIG. 9F by the UI control unit 0303 of the client computer 0101.

The dialog 0928 is a dialog similar to the dialog 0916. Texts 0929 to 0931 are texts similar to the texts 0917 to 0920. The button 0932 is a button similar to the button 0922. For example, the CPU 0201 may detect press of the button 0932 to close the dialog 0928 and end the processing of the flowchart of FIG. 8.

According to the present embodiment, when the objects 0402 to 0409 of the document data 0401 include objects whose signal values are specified in a plurality of color spaces, respectively, the objects 0402 to 0409 of the document data 0401 are analyzed to generate the object information 0501. Based on the object information 0501, it is determined whether there are a plurality of color spaces in the signal values of the objects 0402 to 0409. When it is determined that there are a plurality of color spaces, signal values are respectively extracted for each color space from the document data 0401 and the aligned image data of the color sample scan data 0410 based on the object information 0501. A color conversion table for each color space is created based on the signal values extracted for each color space, and a color matching color profile for each color space is created based on the created color conversion table.

When the color matching color profile is created as described above, the object included in the document data is subjected to color matching for each color space by using the color profile and output by print or the like. The created color profile converts the color space of the object into an apparatus-independent, e.g., Lab color space. The document data may be once converted into a signal value of the Lab color space, then converted into a signal value of the apparatus-dependent color space of the image forming apparatus 0102, and then printed to the image forming apparatus 0102.

The color conversion may be performed, by for example, the color conversion unit 0311, on the object separation image data for each color space generated by the object separation image data generation unit 0308. Thus, after being converted into a signal value of the apparatus-independent color space, the document data may be further converted into, for example, a signal value of the apparatus-dependent color space (e.g., device CMYK corresponding to the color component of toner), and bitmap image data may be generated by the bitmap image data generation unit 0309 and printed. Alternatively, print may be performed by performing color conversion with a color profile in which a color matching color profile and a color profile of the apparatus-dependent color space are synthesized. In a case where the color profile is configured for discrete signal values, the signal values may be converted while being interpolated.

When there are a plurality of color spaces in the signal value of the objects 0402 to 0409 of the document data 0401, it has been difficult for a known technique to create, for each color space, a highly accurate color conversion table for reproducing the same color as the color sample. According to the present embodiment, it is possible to appropriately determine the color spaces of the objects 0402 to 0409 of the document data 0401 to create, for each color space, the color conversion table for reproducing the same color as the color sample and create the color matching color profile for each color space. By this, even if there are a plurality of color spaces in the signal values of the objects 0402 to 0409 of the document data 0401, use of the color matching color profile for each color space enables the same color as the color sample to be reproduced to print the document data 0401. Furthermore, by aligning the document data and the color sample data, the color matching of the color of the corresponding area can be accurately performed among the respective data.

In FIG. 8, it is determined whether or not there are a plurality of color spaces used in the object included in the document data in S805, but S805 and S812 to S817 may be omitted. In that case, regardless of one color space or two or more color spaces, a color conversion table may be created for each color space used in the object included in the document data in S806 to S811.

Furthermore, for each object in single color such as a graphics object or a text object, there may be at least one target area for sampling the signal value when the color conversion table is created. On the other hand, for an object including gradation, for example, a graphics object or a bitmap object such as a photograph including a plurality of colors, it is desirable to divide one object into a plurality of areas and perform sampling on a signal value for each area.

### Second Embodiment

In S810 of the first embodiment, since there are two color spaces, CMYK and RGB, of the signal values of the objects 0402 to 0409 of the document data 0401, a color matching color profile of CMYK and a color matching color profile of RGB are created. However, there is a case where the user desires to print the objects 0403 and 0407 of RGB of the document data 0401 using a predetermined color profile (e.g., AdobeRGB) without using the color matching color profile of RGB. In that case, creation of a color matching color profile of RGB is unnecessary.

Therefore, in a case where there are a plurality of color spaces of the signal values of the objects 0402 to 0409 of the document data 0401, the CPU 0201 receives selection of a color space in which the user desires to reproduce the same color as the color sample in the document data 0401. Thereafter, a method of creating a color conversion table for reproducing the same color as the color sample of only a specific color space desired by the user is provided.

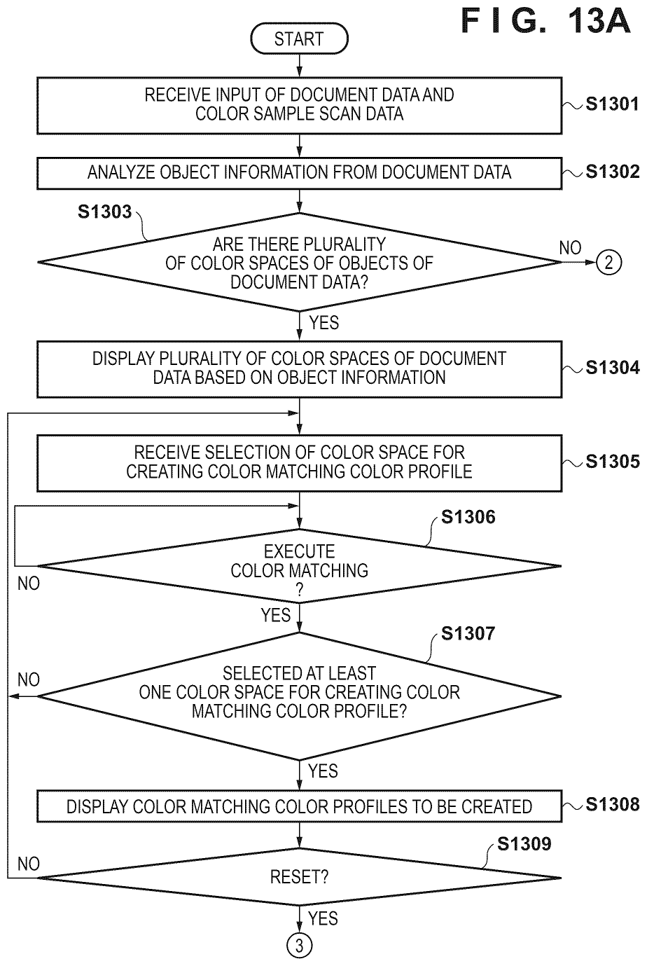

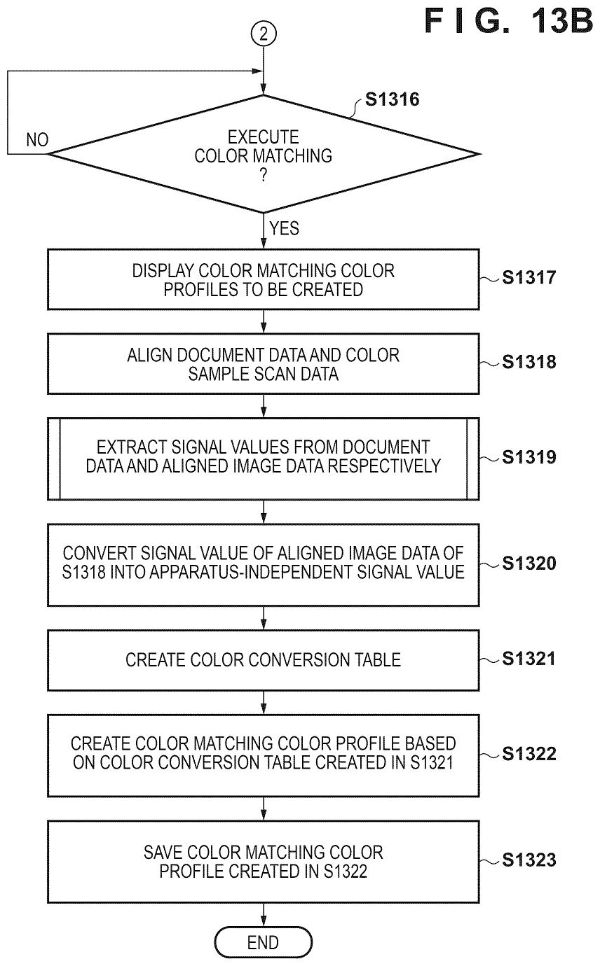

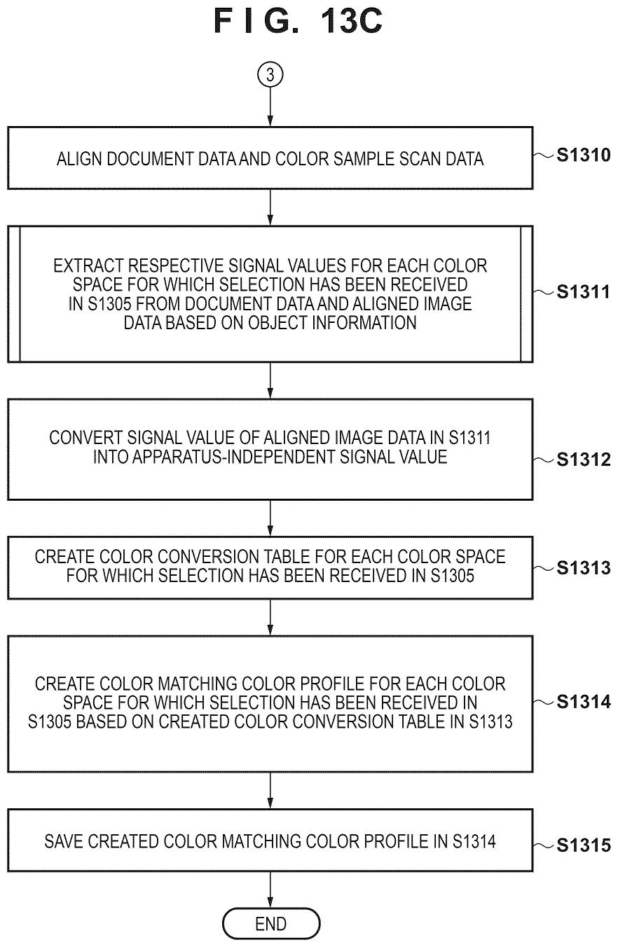

FIGS. 13A to 13C are flowcharts in which the CPU 0201 determines the color space included in the document data 0401 or 1101 to receive selection of the color space and create a color matching color profile of only the selected color space. When receiving a request for creating a color matching color profile for reproducing the document data 0401 with the same color as the color sample from the document data 0401 and the color sample scan data 0410, the CPU 0201 starts the processing of the flowchart of FIG. 13A. Alternatively, when receiving a request for creating a color matching color profile for reproducing the document data 1101 with the same color as the color sample from the document data 1101 and the color sample scan data 1110, the CPU 0201 starts the processing of the flowchart of FIG. 13A. Note that since FIGS. 13A to 13C are a series of processing, even if there is a change, from FIGS. 13A to 13C, the drawings including the processes being described, the change is not particularly described. Upon starting the processing of the flowchart of FIG. 13A, the CPU 0201 displays the window 0901 onto the display unit 0205 by the UI control unit 0303 of the client computer 0101.

First, in S1301, the CPU 0201 performs processing similar to that in S801.

Next, in S1302, the CPU 0201 performs processing similar to that in S804. Note that the CPU 0201 may asynchronously execute the processing of S1302 without waiting for the reception of the input of the color sample scan data 0410 or 1110 at the time point of receiving the input of the document data 0401 or 1101 in S1301.

Next, in S1303, the CPU 0201 performs processing similar to that in S805. In the present embodiment, by the color space determination unit 0307 of the client computer 0101, the CPU 0201 determines that there are a plurality of color spaces of the objects 0402 to 0409 of the document data 0401 to execute the processing of S1304 (S1303: Y). On the other hand, by the color space determination unit 0307 of the client computer 0101, the CPU 0201 determines that the number of the color spaces of the objects 1102 to 1109 of the document data 1101 is not a plurality to execute the processing of S1316 (S1303: N).

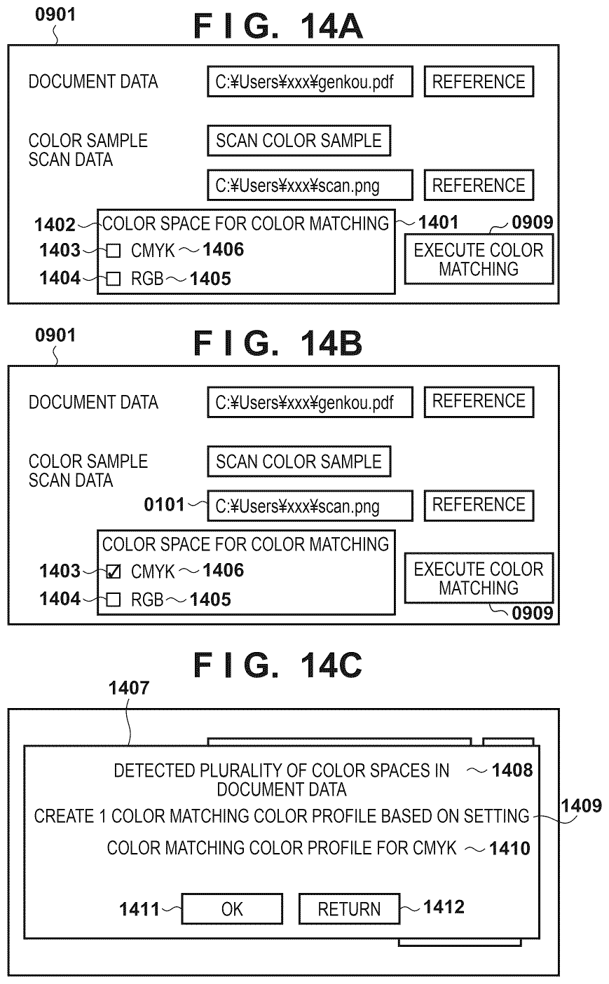

Next, in S1304, by the UI control unit 0303 of the client computer 0101, the CPU 0201 displays, on the display unit 0205, the plurality of color spaces of the objects 0402 to 0409 of the document data 0401 based on the object information 0501. For example, the CPU 0201 displays, on the window 0901, a UI 1401 (FIG. 14A), which is a selection screen of a color space. In the present embodiment, since there are two color spaces, CMYK and RGB, of the objects 0402 to 0409 of the document data 0401, two texts 1405 and 1406 representing CMYK and RGB and two checkboxes 1403 and 1404 are displayed.

FIG. 14A is an example of the UI 1401 for receiving selection of a color space for creating a color matching color profile in a case where there are a plurality of color spaces of the objects 0402 to 0409 of the document data 0401. The text 1402 is a text indicating receiving selection of the color space for creating the color matching color profile. The selection of the color space is performed by the user checking the checkbox for each candidate color space, and information indicating the color space selected by the UI is saved to be referred to when the color conversion table is created.

The checkbox 1403 is a checkbox for selecting whether or not to create a color matching color profile of CMYK. The checkbox 1404 is a checkbox for selecting whether or not to create a color matching color profile of RGB.

The text 1405 is a text indicating that selection of whether or not to create a color matching color profile of RGB has been received. The text 1406 is a text indicating that selection of whether or not to create a color matching color profile of CMYK has been received.

Next, in S1305, the CPU 0201 receives selection of a color space for creating a color matching color profile. For example, the CPU 0201 detects a signal from the UI control unit 0303 of the client computer 0101 to determine whether the checkboxes 1403 and 1404 are checked and receives selection of a color space for creating a color matching color profile. FIG. 14B is an example of a UI indicating that the checkbox 1403 is checked. In FIG. 14B, the CPU 0201 creates a color matching color profile of CMYK, and receives not creating a color matching color profile of RGB. In the present embodiment, a description will be given with an example in which the CPU 0201 creates a color matching color profile of CMYK with respect to the document data 0401 in S1305 and receives not creating a color matching color profile of RGB.

Next, in S1306, the CPU 0201 performs processing similar to that in S802. When the color matching execution button 0909 is pressed (e.g., click operation or the like), the selected color space is determined. When detecting press of the button 0909, the CPU 0201 executes the processing of S1307. On the other hand, when not detecting press of the button 0909, the CPU 0201 executes the processing of S1306 again.

Next, in S1307, the CPU 0201 determines whether selection of at least one color space for creating a color matching color profile is received in S1305. When receiving selection of at least one color space for creating the color matching color profile in S1305, the CPU 0201 executes the processing of S1308. On the other hand, when not receiving selection of at least one color space for creating the color matching color profile in S1305, the CPU 0201 executes the processing of S1305.

Next, in S1308, the CPU 0201 performs processing similar to that in S806. For example, by the UI control unit 0303 of the client computer 0101, the CPU 0201 displays a dialog 1407 illustrated in FIG. 14C. The dialog 1407 includes the number of color profiles to be created (i.e., the number of selected color spaces) and character strings indicating the respective color spaces.

The dialog 1407 is a dialog similar to the dialog 0910. A text 1408 is a text indicating the determination result of S1303. A text 1409 is a text indicating the number of color matching color profiles to be created by the CPU 0201 based on the processing result of S1305. In the present embodiment, that since the CPU 0201 creates only a color matching color profile of CMYK, it is indicated to create one color matching color profile. If the number of the selected color spaces is 2 or more, the number is displayed in place of “1”. A text 1410 is a text similar to the text 0913. A text indicating the selected color space serving as the target of color profile creation is displayed. A button 1411 is a button similar to the button 0915. For example, the CPU 0201 detects press of the button 1411 to execute the next processing. A button 1412 is a button for closing the dialog 1407 to execute the processing of S1305. For example, the CPU 0201 detects press of the button 1412 to execute the processing of S1305 and perform reception of selection of the color space for creating the color matching color profile over again.

Next, in S1309, the CPU 0201 receives whether to perform selection over again regarding the color space for creating the color matching color profile having received selection in S1305. For example, by the UI control unit 0303 of the client computer 0101, the CPU 0201 detects press of the button 1412, thereby executing the processing of S1305 (S1309: N). Alternatively, by the UI control unit 0303 of the client computer 0101, the CPU 0201 detects press of the button 1411, thereby executing the processing of S1310 (S1309: Y).

Next, in S1310, the CPU 0201 executes processing similar to that in S803.

Specifically, by the image alignment unit 0305 of the client computer 0101, the CPU 0201 aligns the color sample scan data 0410 using the document data 0401 and the color sample scan data 0410. The CPU 0201 generates the aligned image data of the color sample scan data 0410 as a processing result of S1310.

Next, in S1311, based on the object information 0201, the CPU 0201 extracts respective signal values for each color space for which selection has been received in S1305 from the aligned image data of the document data 0401 and the color sample scan data 0410.

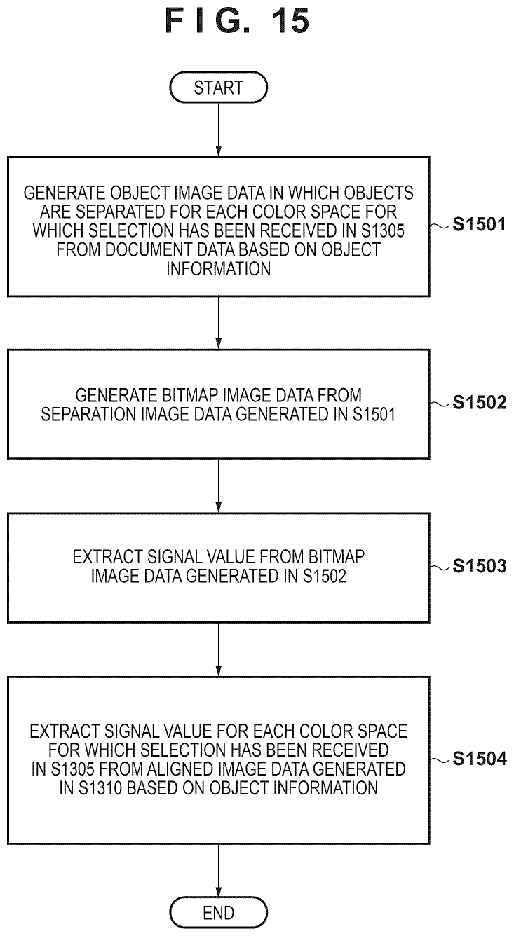

Here, the flow of the processing of S1311 will be specifically described with reference to the flowchart of FIG. 15A. When starting the processing of S1311, the CPU 0201 starts the processing of the flowchart of FIG. 15A.

First, in S1501, the CPU 0201 executes processing similar to that in S1001. Specifically, by the object separation image data generation unit 0308 of the client computer 0101, the CPU 0201 generates object separation image data for each color space for which selection has been received in S1305 from the document data 0401. The object separation image data to be generated is image data in which objects are separated for each color space selected from the color spaces used in the document data. For example, since the CPU 0201 receives creating only color matching color profile of CMYK in S1305, only the object separation image data 0601 is generated in S1501.

Next, in S1502, the CPU 0201 executes processing similar to that in S1002. That is, by the bitmap image data generation unit 0309 of the client computer 0101, the CPU 0201 generates bitmap image data from the object separation image data of respective color spaces generated in S1501. Here, the CPU 0201 generates only bitmap image data of CMYK from the object separation image data 0601.

Next, in S1503, the CPU 0201 executes processing similar to that in S1003. That is, by the signal value extraction unit 0310 of the client computer 0101, the CPU 0201 extracts signal values from respective bitmap image data for each color space generated in S1502 to generate an extracted signal value table. Here, by the signal value extraction unit 0310 of the client computer 0101, the CPU 0201 extracts a signal value from the bitmap image data of CMYK, and generates only the extracted signal value table 0701.

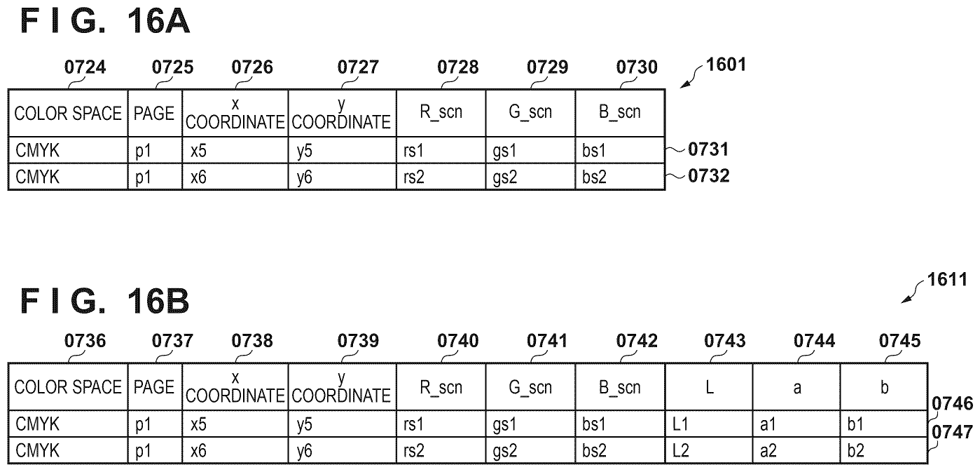

Finally, in S1504, the CPU 0201 executes processing similar to that in S1004. That is, by the signal value extraction unit 0310 of the client computer 0101, the CPU 0201 extracts a signal value for each color space from the aligned image data generated in S1310 based on the object information 0501. Furthermore, the CPU 0201 generates an extracted signal value table from the extracted signal value. Specifically, in the present example, by the signal value extraction unit 0310 of the client computer 0101, the CPU 0201 extracts a signal value for each color space for which selection has been received in S1305 from the aligned image data of the color sample scan data 0410 generated in S1310. Thereafter, by the signal value extraction unit 0310 of the client computer 0101, the CPU 0201 generates an extracted signal value table 1601 (FIG. 16A) as an extracted signal value. At this time, both pages and areas are selected such that the area of the object separation image data for each color space serving as the target of extracting the signal value corresponds to the area of the aligned image data of the color sample scan data 0410. This is similar to the first embodiment.

FIG. 16A illustrates a part of an extracted signal value table 1601 to be stored in the data management unit 0301 by the signal value extraction unit 0310 as a processing result by the signal value extraction unit 0310 for the aligned image data of the color sample scan data 0410 generated in S1310. The signal value extraction unit 0310 acquires a visible area of the color space for which selection has been received in S1305 from the object information 0501. On the aligned image data of the color sample scan data 0410 generated in S1310, the signal value extraction unit 0310 scans an area corresponding to the acquired visible area in a rectangular area having a predetermined size, and treats a mean value of signal values in the rectangular area as a signal value to be extracted. The extracted signal value table 1601 has a similar configuration to that of the extracted signal value table 0722.

The description returns to the flowchart of FIG. 13A. In S1312, the CPU 0201 executes processing similar to that in S808. The CPU 0201 generates an extracted signal value table 1611 illustrated in FIG. 16B as a processing result of S1311.

FIG. 16B illustrates an example in which the color conversion unit 0311 converts the signal values of the scanner-dependent RGB of the items 1606 to 1608 in the extracted signal value table 1601 into the Lab color space using the scanner profile. The extracted signal value table 1611 has a similar configuration to that of the extracted signal value table 0735.

Next, in S1313, the CPU 0201 executes processing similar to that in S809. Specifically, by the color conversion table creation unit 0312 of the client computer 0101, the CPU 0201 creates a color conversion table for each color space for which selection has been received in S1305. For example, since the CPU 0201 receives creating only color matching color profile of CMYK in S1305, only the color conversion table 0750 is created in S1313.

Next, in S1314, the CPU 0201 executes processing similar to that in S810. Specifically, by the color profile creation unit 0313 of the client computer 0101, the CPU 0201 creates a color matching color profile for each color space for which selection has been received in S1305. For example, since the CPU 0201 receives creating only color matching color profile of CMYK in S1305, only the color matching color profile of CMYK is created in S1314.

Next, in S1315, the CPU 0201 executes processing similar to that in S811. For example, by the UI control unit 0303 of the client computer 0101, the CPU 0201 displays a UI similar to the dialog 0928 on the display unit 0205.

Hereinafter, the subsequent processing of S1316 to S1323 after the CPU 0201 determines in S1303 that the number of the color spaces of the objects 1102 to 1109 of the document data 1101 is not a plurality (S1303: N) will be described.

In S1316, the CPU 0201 executes processing similar to that in S1306. Next, in S1317, the CPU 0201 executes processing similar to that in S812.

Next, in S1318, the CPU 0201 executes processing similar to that in S803. Specifically, by the image alignment unit 0305 of the client computer 0101, the CPU 0201 aligns the color sample scan data 1110 using the document data 1101 and the color sample scan data 1110. The CPU 0201 generates the aligned image data of the color sample scan data 1110 as a processing result of S1318.

Regarding S1319 to S1323, the CPU 0201 executes processing similar to that in S813 to S817.

Note that after S1317, the processing branches to S1310, and S1318 to S1323 may be omitted. In that case, in and after S1310, a color profile may be created for each color space of the object included in the document data.

According to the present embodiment, when there are a plurality of color spaces in the signal values of the objects 0402 to 0409 of the document data 0401, the objects 0402 to 0409 of the document data 0401 are analyzed to generate the object information 0501. Based on the object information 0501, it is determined whether there are a plurality of color spaces in the signal values of the objects 0402 to 0409, and when it is determined that there are a plurality of color spaces, selection of a color space for creating a color matching color profile is received. Based on the object information 0501, signal values are extracted respectively from the document data 0401 and the aligned image data of the color sample scan data 0410 for each color space for which selection has been received. A color conversion table for each color space for which selection has been received is created based on the extracted signal values, and a color matching color profile for each color space for which selection has been received is created based on the created color conversion table.

Therefore, when there are a plurality of color spaces in the signal values of the objects 0402 to 0409 of the document data 0401, it is possible to create a color matching color profile of only a color space desired by the user. This can efficiently create a color matching color profile.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-145866, filed Aug. 27, 2024 which is hereby incorporated by reference herein in its entirety.

What is claimed is:

1. An information processing apparatus that performs color matching based on document data and scan data, the information processing apparatus comprising:
at least one memory storing instructions; and
at least one processor that is in communication with the at least one memory and that, when executing the instructions, cooperates with the at least one memory to execute processing, the processing including
receiving an input of document data and an input of scan data,
aligning the document data and the scan data, and
creating a color conversion table for color matching for at least one color space of an object included in the document data based on the document data and the scan data that have been aligned.

2. The information processing apparatus according to claim 1, wherein the processing further includes
generating bitmap image data, and
the aligning includes generating bitmap image data by a generation unit based on the document data and aligning the scan data in accordance with the bitmap image data.

3. The information processing apparatus according to claim 2, wherein
the aligning includes aligning the scan data with the bitmap image data generated based on the document data by translating and rotating the scan data.

4. The information processing apparatus according to claim 1, wherein
the creating includes creating the color conversion table for each of the at least one color space of the object included in the document data.

5. The information processing apparatus according to claim 1 further comprising:
a display that displays a user interface; and
an operation unit that receives a user's input, wherein
the processing includes displaying, on the user interface, a selection screen for selecting a desired color space from the at least one color space of the object included in the document data, and
receiving an input of selection of the color space by the operation unit, and
the creating includes creating the color conversion table for the color space having been selected.

6. The information processing apparatus according to claim 1, wherein
the scan data is data in which a color sample image is read by an image scanner, and
the color conversion table is a table in which a signal value of the object of each of the at least one color space included in the document data is associated with a signal value of an apparatus-independent color space.

7. The information processing apparatus according to claim 1, wherein
the creating includes
generating, based on the object, object separation image data in which an object is separated for each of the at least one color space from the document data, and
generating bitmap image data for each of the at least one color space based on the object separation image data, and
in the generating, the color conversion table is created by associating a signal value for each of the at least one color space, respectively extracted from the bitmap image data of each of the at least one color space, with a signal value extracted from a corresponding area of the scan data.

8. The information processing apparatus according to claim 7, wherein
the signal value of the corresponding area of the scan data is an apparatus-independent signal value based on the signal value of the corresponding area of the scan data.

9. The information processing apparatus according to claim 1 further comprising
a display that displays a user interface, wherein
the processing includes displaying, on the user interface, the at least one color space in which the color conversion table is created, before creating the color conversion table of each of the at least one color space by the creating.

10. The information processing apparatus according to claim 1 further comprising
a display that displays a user interface, wherein
the processing includes displaying, on the user interface, the at least one color space in which the color conversion table has been created, after having created the color conversion table of each of the at least one color space by the creating.

11. The information processing apparatus according to claim 1, wherein the processing further includes
converting a color of the document data into a color of an image formed by the image forming apparatus for each of the at least one color space, using the color conversion table.

12. A non-transitory computer-readable storage medium storing a program that, when loaded on a computer to be executed, causes the computer to execute processing, wherein the processing includes
receiving an input of document data and an input of scan data,
aligning the document data and the scan data, and
creating a color conversion table for color matching for at least one color space of an object included in the document data based on the document data and the scan data that have been aligned.

13. An image forming system including an information processing apparatus that performs color matching based on document data and scan data,
an image forming apparatus, and
an image scanner,
the information processing apparatus comprising:
at least one memory storing instructions; and
at least one processor that is in communication with the at least one memory and that, when executing the instructions, cooperates with the at least one memory to execute processing, the processing including
receiving an input of document data and an input of scan data,
aligning the document data and the scan data, and
creating a color conversion table for color matching for at least one color space of an object included in the document data based on the document data and the scan data that have been aligned.

14. A creation method of a color conversion table by an information processing apparatus that performs color matching based on document data and scan data, the creation method comprising:
receiving an input of document data and an input of scan data;
aligning the document data and the scan data; and
creating a color conversion table for color matching for at least one color space of an object included in the document data based on the document data and the scan data that have been aligned.
